(19) United States
(12) Patent Application Publication
(10) Pub. No.: US 2008/0015772 A1
(43) Pub. Date: Jan. 17, 2008

(54) Drive-assist information providing system for driver of vehicle

(75) Inventors: Norio Sanma, Okazaki-shi (JP); Masanori Kawaura, Aichi-ken (JP); Masakazu Kagawa, Inuyama-shi (JP); Yasuo Yoshikawa, Aichi-ken (JP)

Correspondence Address: HARNESS, DICKEY & PIERCE, P.L.C., P.O. BOX 828, BLOOMFIELD HILLS, MI, 48303, US

(73) Assignees: DENSO Corporation, Kariya-city (JP); Nippon Soken, Inc., Nishio-city (JP)

(21) Appl. No.: 11/821,883

(22) Filed: Jun. 26, 2007

(30) Foreign Application Priority Data
Jul. 13, 2006 (JP) 2006-193202

(51) Int. Cl. G01C 21/28; G08G 1/16

(52) U.S. Cl. 701/207

(57) ABSTRACT

A drive-assist information providing system is installed beforehand in a vehicle. The system provides drive-assist information to the driver when the vehicle is running, or temporarily halting, on one lane of a road within a predetermined assist zone. The system includes a first obtaining unit for obtaining a current position and behavior of the vehicle, and a second obtaining unit for obtaining a current position and behavior of an object around the vehicle. The system includes an identifying unit for identifying current circumstances of the vehicle and therearound based on the current position and behavior of the vehicle and on the current position and behavior of the object around the vehicle. The system includes a control unit for controlling how to provide the drive-assist information to the driver of the vehicle depending on the identified current circumstances of the vehicle and therearound.

### CROSS REFERENCE TO RELATED APPLICATIONS

This application is based on Japanese Patent Application 2006-193202 filed on Jul. 13, 2006. This application claims the benefit of priority from the Japanese Patent Application, so that the descriptions of which are all incorporated herein by reference.

### FIELD OF THE INVENTION

The present invention relates to a drive-assist information providing system. Such a drive-assist information providing system installed in a vehicle is operative to, when the vehicle changes direction at a traffic intersection while crossing an opposing lane, provide drive-assist information to a driver of the vehicle. For example, when a vehicle turns right in left-side traffic or left in right-side traffic, a drive-assist information providing system installed in the vehicle is operative to provide drive-assist information to a driver of the vehicle. The drive-assist information to be provided for the driver for example includes picked-up images of the traffic intersection and its surroundings, and information associated with other vehicles around the vehicle.

### BACKGROUND OF THE INVENTION

Active safety systems in specific zones, such as traffic intersections, have been developed toward practical use.

For example, an active safety system installed in a vehicle is designed to, when the vehicle enters into a traffic intersection, access a camera located at the traffic intersection or its peripheries; this camera works to pick up images of the traffic intersection and its surroundings.

The active safety system is designed to receive, based on the access result, the picked-up images from the camera using inter-vehicle communications and/or vehicle-roadside communications via vehicle-roadside communication units (roadside devices). The active safety system is designed to provide drive-assist information based on the received picked-up images to the driver of the vehicle.

For example, as an example of such active safety systems, a right-turn assist system installed in a vehicle is disclosed in Japanese Unexamined Patent Publication No. H09-270097.

When the vehicle running, or temporarily halting, on one lane of a double-lane road to approach a traffic intersection tries to turn right thereat, the right-turn assist system is designed to receive image data of an oncoming vehicle picked up by a device installed on the traffic intersection; this oncoming vehicle approaches the traffic intersection.

In parallel with the image data receiving task, the right-turn assist system is designed to access the device thereby to receive right-turn timing information from the device; this right-turn timing information is indicative of whether the vehicle can safely turn right at the traffic intersection. The right-turn timing information has been calculated by the device based on the picked-up image data and data currently indicated by a traffic light installed on the one lane close to the traffic intersection.

The right-turn assist system is designed to provide, as drive-assist information, the received image data and the right-turn timing information to the driver of the vehicle.

As another example of such active safety systems, an advanced cruise-assist highway system (AHS) installed in a vehicle is disclosed in Japanese Unexamined Patent Publication No. 2005-11252.

Before the vehicle running or temporarily halting on one lane of a double-lane road to approach a traffic intersection turns right, the AHS works to communicate with DSRC (Dedicated Short Range Communications) devices located at the roadside of the opposing lane to thereby receive oncoming vehicle information from the DSRC devices. The oncoming vehicle information indicates the existence of at least one oncoming vehicle approaching the traffic intersection on the opposing lane.

The AHS works to provide, as drive-assist information, the oncoming vehicle information to the driver of the vehicle in visible and/or audible form. This allows, even if an oncoming vehicle approaching the traffic intersection cannot be visibly recognized by the driver due to the existence of an obstacle, the driver to visibly and/or audibly recognize the existence of oncoming vehicles.

In vehicles in which such an active safety system has been installed, reduction of driver distraction is necessary when drive-assist information is provided to the drivers; this driver distraction means an attention given to the drive-assist information as a non-driving related activity.

Moreover, such an active safety system installed in a vehicle may provide drive-assist information to the driver who needs not necessarily desire the information depending on circumstances of the vehicle and therearound. In this case, the drive-assist information may become bothersome for the driver.

For these reasons, in vehicles in which such an active safety system has been installed, depending on circumstances of the vehicles and therearound, it is desirable to be able to limit, to drivers, the provision of drive-assist information; and/or change the descriptions of drive-assist information.

Circumstances estimated to be required to limit the provision of some items of drive-assist information and/or change the descriptions of some items of drive-assist information include the following:

circumstances where a vehicle in which such an active safety system has been installed is waiting to enter into a traffic intersection for turning right thereat and another vehicle in front of the vehicle is waiting to enter into the traffic intersection for turning right at the traffic intersection. These circumstances will be referred to as “right-turn queue circumstances” hereinafter.

Under the right-turn queue circumstances, the motion of the vehicle is limited by the existence of another vehicle in front of the vehicle. For this reason, the vehicle cannot necessarily turn right in accordance with drive-assist information provided by the active safety system. Thus, under these circumstances, drive-assist information to be given to a driver of the vehicle may not always be useful therefor.

Under the right-turn queue circumstances, the driver of the vehicle can voluntarily draw his/her attention to both another vehicle in front of the vehicle and the traffic intersection independently of drive-assist information.

Thus, the provision of drive-assist information to the driver under the right-turn queue circumstances may become bothersome for the driver.

In addition, it is assumed that a vehicle in which such an active safety system has been installed is located at the front of a queue of vehicles waiting to turn right at a traffic intersection.

In this assumption, depending on the volume of oncoming traffic, it can be expected that the driver of the vehicle will visibly confirm the safety of right-turn at the traffic intersection without using drive-assist information. In this case, drive-assist information given to the driver may become unnecessary and bothersome for the driver.

As set forth above, under the right-turn queue circumstances, in vehicles in which such an active safety system has been installed, it is desirable to be able to limit, to drivers, the provision of drive-assist information and/or change the descriptions of drive-assist information.

In view of the requirements associated with drive-assist information, the right-turn assist system installed in a vehicle and disclosed in Japanese Unexamined Patent Publication No. H09-270097 is configured to determine, based on image data of an oncoming vehicle and data currently indicated by a corresponding traffic light, the timing of provision of drive-assist information to a driver of the vehicle. Specifically, in the right-turn assist system, it is difficult to determine whether drive-assist information to be given to a driver of the vehicle is useful therefor depending on current circumstances of the vehicle and therearound.

This may make it difficult to limit, to the driver, the provision of drive-assist information and/or change the descriptions of drive-assist information depending on current circumstances of the vehicle and therearound.

Concerning the requirements associated with drive-assist information, the AHS installed in a vehicle and disclosed in Japanese Unexamined Patent Publication No. 2005-11252 is configured to:

recognize the existence of at least one oncoming vehicle approaching a traffic intersection on an opposing lane; and

provide, as drive-assist information, the oncoming vehicle information to a driver of the vehicle.

Specifically, in the AHS, it is difficult to determine whether drive-assist information to be given to a driver of the vehicle is useful therefor depending on current circumstances of the vehicle and therearound.

This may make it difficult to limit, to the driver, the provision of drive-assist information and/or change the descriptions of drive-assist information depending on current circumstances of the vehicle and therearound.

### SUMMARY OF THE INVENTION

In view of the background, an object of at least one aspect of the present invention is to provide drive-assist information providing systems, which are capable of determining whether drive-assist information to be given to a driver of a vehicle is useful therefor depending on current circumstances of the vehicle and therearound.

According to one aspect of the present invention, there is provided a drive-assist information providing system installed in a vehicle and designed to provide drive-assist information to a driver of the vehicle when the vehicle is running, or temporarily halting, on one lane of a road within a predetermined assist zone. The system includes a first obtaining unit configured to obtain a current position and behavior of the vehicle, and a second obtaining unit configured to obtain a current position and behavior of at least one object around the vehicle. The system includes an identifying unit configured to identify current circumstances of the vehicle and therearound based on the current position and behavior of the vehicle and on the current position and behavior of the at least one object around the vehicle. The system includes a control unit configured to control how to provide the drive-assist information to the driver of the vehicle depending on the identified current circumstances of the vehicle and therearound.

According to another aspect of the present invention, there is provided a program product embedded in a media accessible by a computer installed in a vehicle for providing drive-assist information to a driver of the vehicle when the vehicle is running, or temporarily halting, on one lane of a road within a predetermined assist zone. The program product includes first means for instructing a computer to, when a current position and behavior of at least one object around the vehicle is externally input thereto, receive the current position and behavior of at least one object around the vehicle. The program product includes second means for instructing a computer to, when a current position and behavior of at least one object around the vehicle is externally input thereto, receive the current position and behavior of the at least one object around the vehicle. The program product includes third means for instructing a computer to identify current circumstances of the vehicle and therearound based on the current position and behavior of the vehicle and on the current position and behavior of the at least one object around the vehicle. The program product includes fourth means for instructing a computer to control how to provide the drive-assist information to the driver of the vehicle depending on the identified current circumstances of the vehicle and therearound.

### BRIEF DESCRIPTION OF THE DRAWINGS

Other objects and aspects of the invention will become apparent from the following description of embodiments with reference to the accompanying drawings in which:

FIG. 1 is a block diagram schematically illustrating an example of the overall structure of a drive-assist information providing system according to an embodiment of the present invention;

FIG. 2 is a block diagram schematically illustrating an example of the structure of an in-vehicle drive-assist unit illustrated in FIG. 1;

FIG. 3 is a view schematically illustrating a first provision mode of drive-assist information by the drive-assist information providing system under first circumstances in which a forward right-turn vehicle is running, or temporarily halting in front of a vehicle that wants to turn right at a traffic intersection;

FIG. 4 is a view schematically illustrating a second provision mode of drive-assist information by the drive-assist information providing system under second circumstances in which there is an oncoming right-turn vehicle and there are no forward right-turn vehicles in front of the vehicle that wants to turn right at the traffic intersection;

FIG. 5 is a view schematically illustrating a third provision mode of drive-assist information by the drive-assist information providing system under third circumstances in which there are no oncoming right-turn vehicles and no forward right-turn vehicles in front of the vehicle that is temporarily halting at the traffic intersection in order to turn right thereat;

FIG. 6 is a view schematically illustrating a fourth provision mode of drive-assist information by the drive-assist information providing system under fourth circumstances in which there is a traffic jam in opposing lanes of the load and there are no oncoming right-turn vehicles and no forward right-turn vehicles in front of the vehicle that is temporarily halting at the traffic intersection in order to turn right thereat;

FIG. 7 is a view schematically illustrating a fifth provision mode of drive-assist information by the drive-assist information providing system under fifth circumstances in which there is an oncoming right-turn vehicle and there are no forward right-turn vehicles in front of the vehicle that is running at the traffic intersection;

FIG. 8 is a view schematically illustrating a sixth provision mode of drive-assist information by the drive-assist information providing system under sixth circumstances in which there are no traffic jams in opposing lanes of the load, no oncoming right-turn vehicles, and no forward right-turn vehicles in front of the vehicle that is temporarily halting at the traffic intersection in order to turn right thereat;

FIG. 9A is a view schematically illustrating, as an example of drive-assist images, a camera image displayed on a screen of a display device illustrated in FIG. 1;

FIG. 9B is a view schematically illustrating, as an example of drive-assist images, an animation image displayed on a screen of a display device illustrated in FIG. 1;

FIG. 10 is a flowchart schematically illustrating a drive-assist information providing task to be executable by the in-vehicle drive-assist unit illustrated in FIG. 1; and

FIG. 11 is a flowchart schematically illustrating a modification of the drive-assist information providing task to be executable by the in-vehicle drive-assist unit illustrated in FIG. 1.

### DETAILED DESCRIPTION OF EMBODIMENTS OF THE INVENTION

An embodiment of the present invention will be described hereinafter with reference to the accompanying drawings. In the drawings, identical reference characters are utilized to identify identical corresponding components.

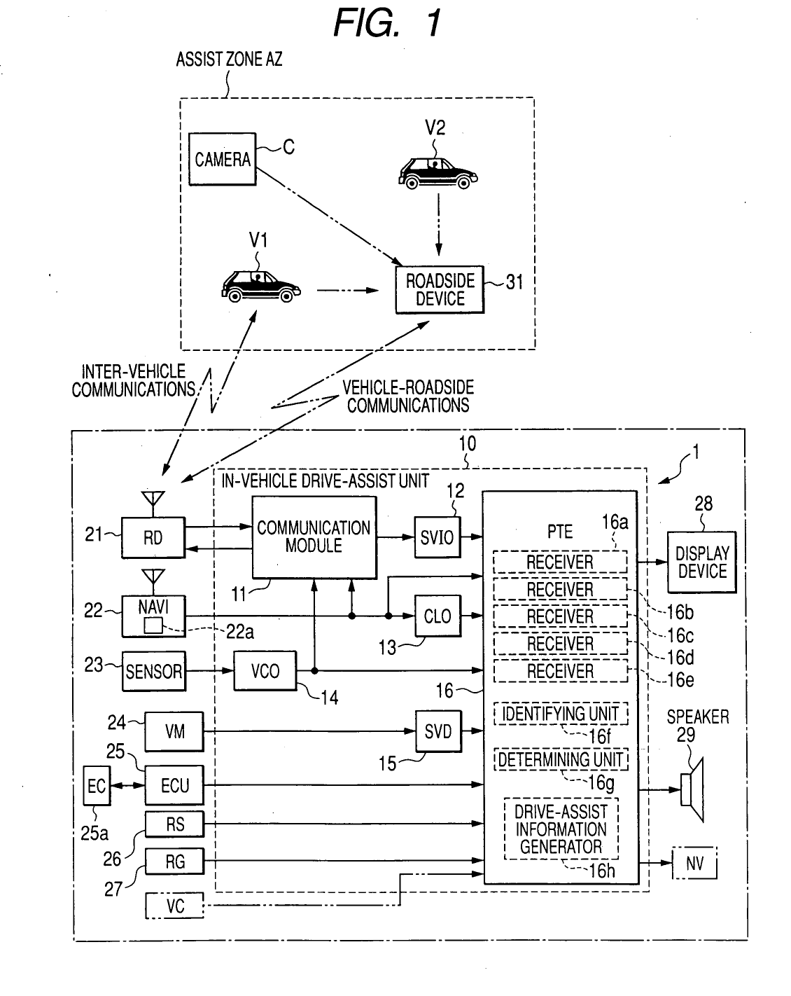

Referring to FIG. 1, an example of the structure of a drive-assist information providing system 1 is illustrated.

Specifically, the drive-assist information providing system 1 includes an in-vehicle drive-assist unit 10 installed in a vehicle V; this in-vehicle drive-assist unit 10 for example corresponds to a drive-assist information providing device according to the invention. The drive-assist information providing system 1 also includes various types of in-vehicle devices communicably coupled to the drive-assist unit 10.

The in-vehicle devices include a radio device (abbreviated as “RD” in FIG. 1) 21, a navigation device (abbreviated as “NAVI” in FIG. 1) 22, in-vehicle sensors (abbreviated as “SENSOR” in FIG. 1) 23, and a vehicle periphery monitoring device (abbreviated as “VM” in FIG. 1) 24. The in-vehicle devices also include a body ECU (abbreviated as “ECU” in FIG. 1) 25, a solar radiation sensor (abbreviated as “RS” in FIG. 1) 26, a rain gauge (abbreviated as “RG” in FIG. 1) 27, a display device 28, and a speaker 29.

The radio device 21 is operative to wirelessly communicate with a vehicle-roadside communication unit (roadside device) 31 installed on a roadside of, for example, at least one predetermined traffic intersection or its surrounding when the vehicle V is located within a predetermined communicable area containing the at least one traffic intersection and a given radius of the at least one traffic intersection.

In the embodiment, the predetermined communicable area has been established as an assist zone AZ for drive assist of drivers of vehicles located within the assist zone AZ.

The roadside device 31 installed on a roadside contained in the assist zone AZ is operative to wirelessly communicate with radio devices installed in vehicles located within the assist zone AZ to thereby:

detect the existences of the vehicles within the assist zone AZ;

obtain information containing the current positions and behaviors (dynamics) of the vehicles; and

when at least one of the vehicles accesses thereto, send, to the at least one of the vehicles, the obtained information except for information of the at least one of the vehicles.

A camera C is located at a roadside contained in the assist zone AZ and operative to continuously take images in and/or around the at least one traffic intersection of the assist zone AZ.

The roadside device 31 is operative to wirelessly communicate with the camera C and receive the images associated with the at least one traffic intersection of the assist zone AZ to thereby wirelessly transmit the received images to vehicles located within the assist zone AZ.

The radio device 21 installed in the vehicle V is also operative to communicate, using radio waves, with radio devices previously installed in other vehicles located within a communicable zone around the vehicle V to thereby receive information containing the current positions and behaviors of the other vehicles. For example, the communicable zone around the vehicle V has been established to zones within ranges from a radius of several-tens meters to that of several-hundreds meters.

In addition, the radio devices installed in other vehicles located within the communicable zone around the vehicle V are operative to communicate, using radio waves, with the radio device 21 of the vehicle V to thereby receive information containing the current position and behavior of the vehicle V.

The radio device 21 is further operative to transmit, to the drive-assist unit 10, the received information transmitted from the roadside device 31 and that transmitted from at least one of other vehicles, illustrated as “V1” and “V2” in FIG. 1, around the vehicle V.

The navigation device 22 is operative to receive radio signals transmitted from global positioning satellites (GPS). In addition, the navigation device 22 is operative to receive measurement signals indicative of the speed of the vehicle V and sent from a vehicle speed sensor of the in-vehicle sensors 23, and measurement signals indicative of the rate of change of steering angle of the vehicle V and sent from a gyro sensor of the in-vehicle sensors 23.

The navigation device 22 is operative to read out map-matching data stored in a storage medium 22a, such as a DVD-ROM or Hard Disk and read out an electronic map image from an electronic map database stored in the storage medium 22a. The map-matching data can be used in map-matching processes for increasing the accuracy of current position of the vehicle V obtained by the navigation system 22.

Specifically, the navigation device 22 is operative to calculate the current vehicle's exact location with the vehicle running based on the received signals, the electronic map image, and the map-matching data.

The navigation device 22 is operative to display the current vehicle's exact location on the screen of a display device together with the readout electronic map image associated with the vehicle's exact location.

In addition, the navigation system 22 is operative to calculate the best route to occupant's destination from the current location according to occupant's instructions, and give an occupant(s) voice or visual guidance to the destination along the calculated best route using the display device and/or a speaker.

The navigation device 22 is equipped with a receiver operative to receive latest road traffic information including congestion, restriction, guides on road, and parking lots and provided from a VICS® (Vehicle Information and Communication System) center via, for example beacons installed on roadsides. In the embodiment, when the vehicle V is located within the assist zone AZ, the roadside device 31 serves as a beacon to relay, to the navigation device 22, latest road traffic information supplied from the VICS center.

As described above, in the embodiment, an assist zone AZ has been established to a zone containing at least one traffic intersection and a given radius of the at least one traffic intersection.

Specifically, in the embodiment, in the storage medium 22a, information indicative of the position of the assist zone AZ containing at least one traffic intersection and various items of image data to be used for drive-assist images have been stored. The various items of image data include background images to be used for the drive-assist images, image data of vehicles and other traffic items to be superimposed on the background images, and character data to be superimposed on the background images.

Moreover, the navigation system 22 is operative to:

read the information indicative of the position of the assist zone AZ and the various items of image data to be used for drive-assist images; and

transmit, to the in-vehicle drive-assist unit 10, the calculated actual location of the vehicle V, the readout information indicative of the position of the assist zone AZ, and the readout various items of image data to be used for drive-assist images.

The in-vehicle sensors 23 include, in addition to the vehicle speed sensor and the gyro sensor, an acceleration sensor, a brake sensor, in-vehicle clock, and the like. One type of the in-vehicle sensors 23, such as the vehicle speed sensor, the gyro sensor, and the acceleration sensor, is operative to measure a physical quantity associated with the behavior of the vehicle V and send, to the in-vehicle drive-assist unit 10, a measurement signal indicative of the measured physical quantity.

For example, the vehicle speed sensor is so arranged in the vehicle V as to measure the speed of the vehicle V as a physical quantity associated with the behavior of the vehicle V. The gyro sensor is so arranged in the vehicle V as to measure the rate of change of steering angle of the vehicle V as a physical quantity of the behavior of the vehicle V.

The acceleration sensor is so arranged in the vehicle V as to measure an acceleration of the vehicle V as a physical quantity of the behavior of the vehicle V.

Another type of the in-vehicle sensors 23, such as the brake sensor, is operative to detect operating conditions of target devices associated with the behavior of the vehicle V, and send, to the in-vehicle drive-assist unit 10, a measurement signal indicative of the detected operating conditions of the target devices.

The in-vehicle clock is operative to measure the time.

The vehicle periphery monitoring device 24 includes a forward vehicle monitor consists essentially of a common detector, such as a radar, a sonar, or the like, using detection waves.

Specifically, the forward vehicle monitor is operative to transmit, toward the front of the vehicle V, detection waves, such as millimeter waves, laser waves, ultrasonic waves, or the like, so as to horizontally scan, for example, a substantially sector (fan) region in front of the vehicle V.

When waves are reflected from a target object, that is, a forward vehicle, located in front of the vehicle V, the forward vehicle monitor is operative to detect the reflected waves. In addition, the forward vehicle detector is operative to obtain, based on the detected reflected waves, forward vehicle information including a distance between the target object (the forward vehicle) and the vehicle V and a direction of the target object (the forward vehicle) with reference to the vehicle V. The forward vehicle monitor is operative to transmit the obtained forward vehicle information to the in-vehicle drive-assist unit 10.

The body ECU 25 is electrically connected to electrical components (abbreviated as “EC” in FIG. 1) 25a mounted on the body of the vehicle V. The electrical components include a front direction indicator (blinker) mounted on either side of the front of the vehicle V and a rear direction indicator (blinker) mounted on either side of the rear of the vehicle V. The electrical components 25a also include headlights on the front of the body of the vehicle V, and wipers attached to the windshield and the rear window of the body of the vehicle V and operative to clean them.

For example, the body ECU 25 is operative to cause the right direction indicators to blink on in response to the driver's operation of an indicator switch (indicator lever) in a predetermined direction, and cause the left direction indicators to blink on in response to the driver's operation of the indicator switch in another predetermined direction.

The body ECU 25 is operative to control the operating conditions of the headlights, and control the operating conditions of the wipers.

The body ECU 25 is also operative to send, to the in-vehicle drive-assist unit 10, information indicative of operating conditions of the electrical components 25a including the front and rear indicators, the headlights, and the wipers.

The solar radiation sensor 26 is so arranged on the vehicle V as to measure solar radiation and send, to the in-vehicle drive-assist unit 10, an electrical signal indicative of the measured solar radiation.

The rain gauge 27 is so arranged on the vehicle V as to gather and measure the amount of liquid precipitation over a set of time. The rain gauge 27 is operative to send, to the in-vehicle drive-assist unit 10, an electrical signal indicative of the measured amount of liquid precipitation.

The display device 28 consists essentially of, for example, a color liquid crystal display with a predetermined-sized screen. The display device 28 is operative to receive electronic map images and various drive-assist images sent from the in-vehicle drive-assist device 10. The display device 28 is operative to display, on the screen, received electronic map images and the various drive-assist images.

The speaker 29 is operative to receive electrical signals sent from the in-vehicle drive-assist unit 10 and convert the received electrical signals into audible sound information associated with drive-assist information; this audible sound information includes various beep tones and/or voice information.

The in-vehicle drive-assist unit 10 is designed, for example, as a normal computer system, and configured to perform overall control of the drive-assist information providing system 1.

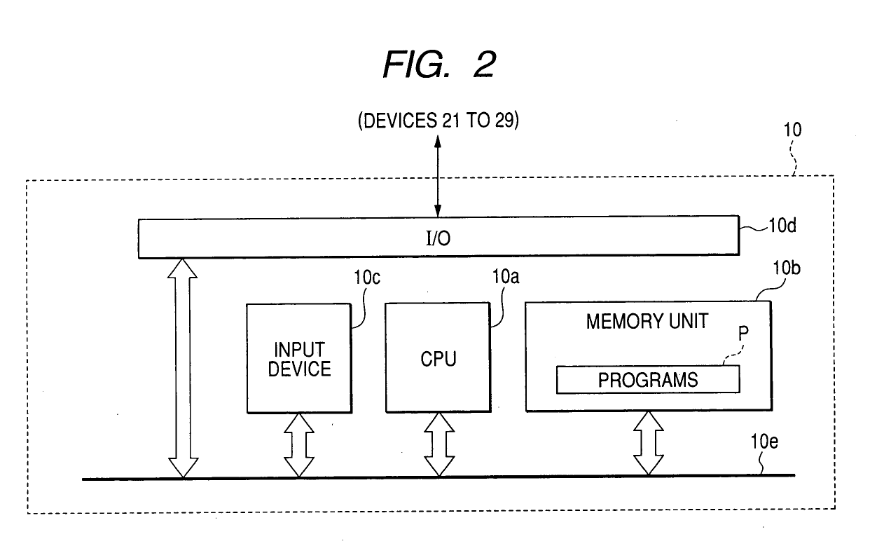

Specifically, as illustrated in FIG. 2, the in-vehicle drive-assist unit 10 consists essentially of a CPU 10a, a memory unit 10b including a ROM, such as a flash ROM and a RAM, an I/O interface 10c, a user-operable input device 10d, and a bus 10e communicably coupling them.

The CPU 10a is operative to perform various tasks including a drive-assist information providing task for drive-assist of the driver of the vehicle V.

For example, the memory unit 10b stores therein a plurality of programs P in advance. At least one of the programs P causes the CPU 10a to execute the various tasks for drive-assist of the driver of the vehicle V. The at least one RAM of the memory unit 10b is for example operative to serve as the CPU's main working memory.

The I/O interface 10c is operative to interface between the peripheral devices 21 to 27 and the CPU 10a so as to allow data communications therebetween.

The user-operable input device 10d is operative to allow the driver and/or a passenger in a front seat of the vehicle V to input, to the CPU 10a, instructions, such as the start of drive-assist information providing task and the termination of drive-assist information providing task.

The in-vehicle drive-assist unit 10 is functionally composed of a communication module 11, a surrounding-vehicle information obtaining module (abbreviated as “SVIO” in FIG. 1) 12, and a current location obtaining module (abbreviated as “CLO” in FIG. 1) 13. In addition, the in-vehicle drive-assist unit 10 is functionally composed of a vehicle condition obtaining module (abbreviated as “VCO” in FIG. 1) 14, a surrounding-vehicle detecting module (abbreviated as “SVD” in FIG. 1) 15, and a provision task executing module (abbreviated as “PTE” in FIG. 1) 16.

In the embodiment, at least one of the programs P stored in the memory unit 10b can cause the CPU 10a to implement all of the functional modules 11 to 16. Otherwise, each of the functional modules 11 to 16 can be implemented by a corresponding at least one program P stored in the memory unit 10b.

The communication module 11 is operatively coupled to the surrounding-vehicle information obtaining module 12 and the vehicle condition obtaining module 14.

The vehicle condition obtaining module 14 works to access the in-vehicle sensors 23 and receive, therefrom, the measurement signals indicative of:

the measured physical quantities associated with the behavior of the vehicle V; these measured physical quantities include the speed, the rate of change of steering angle, and the acceleration of the vehicle V; and

the detected operating conditions of the target devices containing the brakes and associated with the behavior of the vehicle V.

The vehicle condition obtaining module 14 works to determine the driving state of the vehicle V, such as running state or temporary stop state, based on the received measurement signals. The vehicle condition obtaining module 14 works to pass, to the communication module 11 and the provision task executing module 16, the determined driving state of the vehicle V.

The communication module 11 works to access the radio device 21 and control it to thereby receive, at any time, various pieces of information obtained by the radio device 21 based on inter-vehicle communications and/or vehicle-roadside communications via the roadside device 31. Specifically, the various pieces of information include the information containing the current positions and behaviors of other vehicles located within a communicable zone around the vehicle V.

The communication module 11 works to access the navigation device 22 to thereby receive therefrom the information indicative of the current location of the vehicle V. The communication module 11 works to receive the driving state of the vehicle V passed from the vehicle condition obtaining module 14.

The surrounding-vehicle information obtaining module 12 works to receive the various pieces of information passed from the communication module 11; these various pieces of information include the information containing the current positions and behaviors of other vehicles, such as individual speeds thereof, located within a communicable zone around the vehicle V. The information containing the current positions and behaviors of other vehicles located within a communicable zone around the vehicle V will be referred to as “surrounding-vehicle information” hereinafter.

The current location obtaining module 13 works to access the navigation device 22 thereby to obtain the current location of the vehicle V based on the information indicative of the current location of the vehicle V.

The surrounding-vehicle detecting module 15 works to receive the forward vehicle information transmitted from the vehicle peripheral monitoring device 24 to thereby identify the existences (locations) and behaviors of other vehicles located in front of the vehicle V. The surrounding-vehicle detecting module 15 works to pass, to the provision task executing module 16, information indicative of the existences and behaviors of other vehicles located in front of the vehicle V; this information will be referred to as “forward-vehicle information” hereinafter.

The provision task executing module 16 functionally includes:

a first receiver 16a working to receive the driving state of the vehicle V passed from the module 14, the surrounding-vehicle information passed from the module 12, the current location of the vehicle V passed from the current location obtaining module 13, and the forward-vehicle information passed from the surrounding-vehicle detecting module 15;

a second receiver 16b working to receive the readout information from the storage medium 22a of the navigation device 22; this readout information is indicative of the position of the assist zone AZ containing a corresponding at least one traffic intersection and the readout various items of image data to be used for drive-assist images;

a third receiver 16c working to receive the information indicative of operating conditions of the front and rear indicators of the vehicle V sent from the body ECU 25;

a fourth receiver 16d working to receive the electric signal indicative of the measured solar radiation sent from the solar radiation sensor 26;

a fifth receiver 16e working to receive the electrical signal indicative of the measured amount of liquid precipitation sent from the rain gauge 27; and

an identifying unit 16f working to identify current circumstances of the vehicle V and therearound by determining, based on the received pieces of information and the received electric signals, whether:

there are forward vehicles in front of the vehicle V that are running toward at least one traffic intersection, or temporarily halting, on a lane of a corresponding road in order to turn right at the at least one traffic intersection;

there are oncoming vehicles that approach at least one traffic intersection in order to turn right at the at least one traffic intersection;

there are traffic jams in an oncoming lane(s); and

the vehicle V approaching at least one intersection is temporarily halting.

The provision task executing module 16 functionally includes a determining unit 16g working to determine the level of necessity for provision of drive-assist information depending on the identified current circumstances of the vehicle V and therearound.

Specifically, the determining unit 16g works to determine the level of necessity for provision of drive-assist information depending on at least one of the identified current circumstances of the vehicle V and therearound to thereby determine:

whether to provide drive-assist information to the driver of the vehicle V; and

which provision modes of drive-assist information to be given to the driver of the vehicle V when it is determined that provision of drive-assist information is necessary for the driver of the vehicle V.

Furthermore, the provision task executing module 16 functionally includes:

a drive-assist information generator 16h working to generate:

drive-assist images based on at least one of the identified circumstances and on one of the provision modes determined by the determining unit 16f to thereby output the generated images to the display device 28; and/or

drive-assist voice notices based on at least one of the identified circumstances and on one of the provision modes determined by the determining unit 16g to thereby output the generated voice notices to the speaker 29.

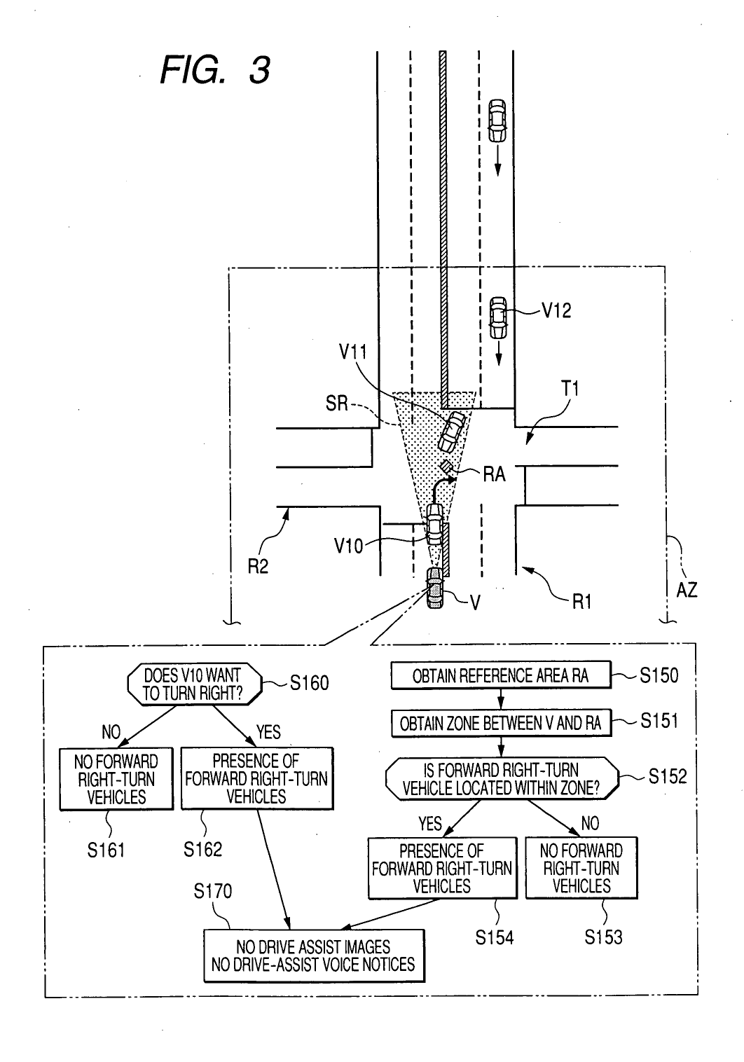

Next, the provision modes to be determined by the determining unit 16g of the provision task executing module 16 depending on the level of necessity for drive-assist information will be described hereinafter with reference to FIGS. 3 to 8.

FIG. 3 schematically illustrates an example of a traffic intersection TI in and around which the assist zone AZ has been established. The traffic intersection TI means a place where a road R1 with two lanes each way and a double-lane road R2 cross each other.

FIG. 3 shows first circumstances in which:

the vehicle V is running, or temporarily halting, on the inner lane of one two-lane section of the road R1 toward the traffic intersection TI in order to turn right at the traffic intersection TI; and

a vehicle V10 is running, or temporarily halting, at least partially on the traffic intersection TI in front of the vehicle V in order to turn right at the traffic intersection TI.

In FIG. 3, reference character V11 represents an oncoming vehicle that is turning right, or temporarily halting, at the traffic intersection TI. Reference character V12 represents a straight oncoming vehicle that is running, or temporarily stopping, toward the traffic intersection TI. Reference character SR represents the scan region (fan region) of the vehicle periphery monitoring device 24.

In this case, because of determining that there is the vehicle V10 that is running, or temporarily halting, at least partially on the traffic intersection TI in front of the vehicle V, the identifying unit 16f identifies that the current circumstances correspond to the first circumstances.

Note that, for example, the determination of the presence or absence of vehicles, referred to as “forward right-turn vehicles”, that are running, or temporarily halting, at least partially on the traffic intersection TI in front of the vehicle V in order to turn right thereat can be carried out as follows:

The identifying unit 16f can carry out the determination of the presence or absence of forward right-turn vehicles based on the forward vehicle information passed from the module 15, the current location of the vehicle V passed from the module 13, and the position of the assist zone AZ (the traffic intersection TI) sent from the navigation device 22.

More specifically, the identifying unit 16f obtains, as a predetermined reference area RA of traffic intersections, the position of the center area of the traffic intersection TI corresponding to an area at which the vehicle V turns right based on the position of the traffic intersection TI in step S150 (see FIG. 3).

Next, the identifying unit 16f obtains a zone between the current location of the vehicle V and the position of the center area RA of the traffic intersection TI within the assist zone AZ in step S151.

The identifying unit 16f determines whether there are forward right-turn vehicles as target objects within the obtained zone based on the forward vehicle information in step S152.

When it is determined that there are not forward right-turn vehicles as target objects within the obtained zone (the determination in step S152 is NO), the identifying unit 16f determines that there are no vehicles that are running, or temporarily halting, at least partially on the traffic intersection TI in front of the vehicle V in step S153. Thus, the identifying unit 16f can identify that the current circumstances do not correspond to the first circumstances.

Otherwise when it is determined that there are forward right-turn vehicles as target objects within the obtained zone (the determination in step S152 is YES), the identifying unit 16f determines that there is the forward right-turn vehicle V10 in front of the vehicle V in step S154. Thus, the identifying unit 16f can identify that the current circumstances correspond to the first circumstances.

Moreover, the identifying unit 16f can also carry out the determination of the presence or absence of forward right-turn vehicles using the surrounding-vehicle information passed from the module 12.

Specifically, the surrounding-vehicle information passed from the module 12 includes the current position and the behavior of the vehicle V10 in front of the vehicle V detected by the radio device 21 using inter-vehicle communications and/or vehicle-roadside communications via the roadside device 31. The behavior of the vehicle V10 includes information of whether its right direction indicators blink on.

The identifying unit 16f determines whether the vehicle V10 in front of the vehicle V wants to turn right based on the current position and the behavior of the vehicle V10 in step S160.

When it is determined that the vehicle V10 does not want to turn right (the determination in step S160 is NO), the identifying unit 16f determines that there are no forward right-turn vehicles in step S161. Thus, the identifying unit 16f can identify that the current circumstances do not correspond to the first circumstances.

Otherwise when it is determined that the vehicle V10 wants to turn right (the determination in step S160 is YES), the identifying unit 16f determines that there is the forward right-turn vehicle V10 in step S162. Thus, the identifying unit 16f can identify that the current circumstances correspond to the first circumstances.

Specifically, when the current circumstances correspond to the first circumstances, the presence of the forward right-turn vehicle V10 has limited the motion of the vehicle V, and therefore, drive-assist information to be given to the driver of the vehicle V under the first circumstances may not always be useful therefor.

Thus, the determining unit 16f determines that the level of necessity for provision of drive-assist information is low, which causes the drive-assist information generator 16h to generate no drive-assist images and no drive-assist voice notices (see steps S170 in FIG. 3).

This allows the display device 28 not to display any drive-assist images, and the speaker 29 not to output any drive-assist voice notices, making it possible to reduce driver distraction due to drive-assist information and/or prevent drive-assist information from becoming bothersome for the driver of the vehicle V.

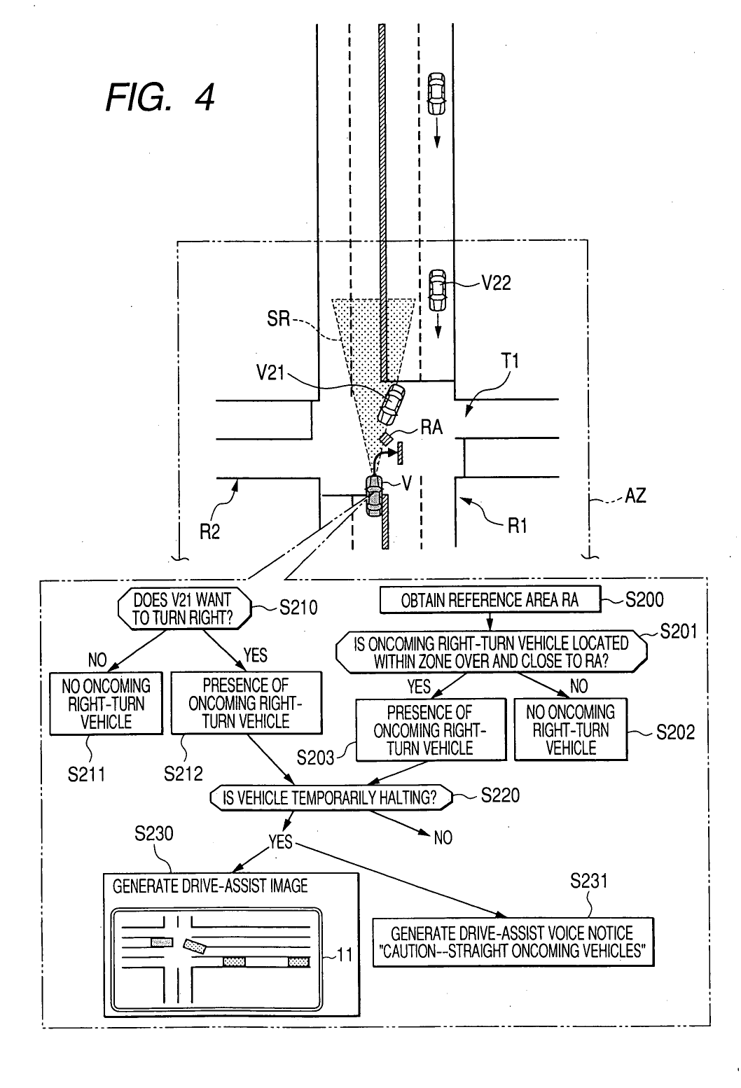

FIG. 4 schematically shows second circumstances in which:

the vehicle V is temporarily halting at the traffic intersection TI on the inner lane of the one two-lane section of the road R1 in order to turn right at the traffic intersection TI;

there are no forward right-turn vehicles on the inner lane of the one two-lane section of the road R1; and

an oncoming vehicle V21 is turning right, or temporarily halting, at the traffic intersection TI.

Note that reference character V22 represents a straight oncoming vehicle that is running, or temporarily stopping, toward the traffic intersection TI.

In this case, the identifying unit 16f determines that:

there are no forward right-turn vehicles (see steps S150 to S153 or steps S160 and S161);

there is an oncoming vehicle that is turning right, or temporarily halting, at the traffic intersection TI; and

the vehicle V is temporarily halting on the inner lane of the one two-lane section of the road R1.

Thus, the identifying unit 16f identifies that the current circumstances correspond to the second circumstances.

Note that, for example, the determination of the presence or absence of an oncoming vehicle, referred to as “oncoming right-turn vehicle” that is turning right, or temporarily halting, at the traffic intersection TI can be carried out as follows:

The identifying unit 16f can carry out the determination of the presence or absence of an oncoming right-turn vehicle based on the forward vehicle information passed from the module 15, the current location of the vehicle V passed from the module 13, and the position of the traffic intersection TI sent from the navigation device 22.

More specifically, the identifying unit 16f obtains, as a predetermined reference area RA of traffic intersections, the position of the center area of the traffic intersection TI corresponding to an area at which the vehicle V turns right based on the position of the traffic intersection TI in step S200 (see FIG. 4).

Next, the identifying unit 16f determines whether there is an oncoming right-turn vehicle within a predetermined zone over and close to the center area RA of the traffic intersection TI based on the forward vehicle information in step S201.

When it is determined that there is not an oncoming right-turn vehicle within the predetermined zone (the determination in step S201 is NO), the identifying unit 16f determines that there are no oncoming right-turn vehicles in step S202. Thus, the identifying unit 16f can identify that the current circumstances do not correspond to the second circumstances.

Otherwise when it is determined that there is an oncoming right-turn vehicle within the predetermined zone (the determination in step S201 is YES), the identifying unit 16f determines that there is the oncoming right-turn vehicle V21 in step S203, proceeding to step S220.

Moreover, the identifying unit 16f can also carry out the determination of the presence or absence of an oncoming right-turn vehicle using the surrounding-vehicle information passed from the module 12.

Specifically, the surrounding-vehicle information passed from the module 12 includes the current position and the behavior of the oncoming vehicle V21 detected by the radio device 21 using inter-vehicle communications and/or vehicle-roadside communications via the roadside device 31. The behavior of the oncoming vehicle V21 includes information of whether its right direction indicators blink on.

The identifying unit 16f determines whether the oncoming vehicle V21 is located within the traffic intersection TI and wants to turn right based on the current position and the behavior of the vehicle V21 in step S210.

When it is determined that either the oncoming vehicle V21 is not located within the traffic intersection TI or does not want to turn right (the determination in step S210 is NO), the identifying unit 16f determines that there are no oncoming right-turn vehicles in step S211. Thus, the identifying unit 16f can identify that the current circumstances do not correspond to the second circumstances.

Otherwise when it is determined that both the oncoming vehicle V21 is located within the traffic intersection TI and wants to turn right (the determination in step S210 is YES), the identifying unit 16f determines that there is the oncoming right-turn vehicle V21 in step S212, proceeding to step S220.

In addition, the identifying unit 16f can determine whether the vehicle V is temporarily halting based on the driving state, such as running state or temporarily halting state, of the vehicle V passed from the vehicle condition obtaining module 14 in step S220. As described above, the driving state of the vehicle V has been obtained by the module 14 based on, for example, the speed and/or the operating conditions of the brakes of the vehicle V.

Specifically, in the second circumferences, because the driving state of the vehicle V is the temporarily haling state, it is determined that the vehicle V is temporarily halting (the determination in step S220 is YES), and therefore, the identifying unit 16f can identify that the current circumstances correspond to the second circumstances.

When the current circumstances correspond to the second circumstances, the determining unit 16f determines that the level of necessity for provision of drive-assist information is high, which causes the drive-assist information generator 16h to generate both a drive-assist image I1 and a drive-assist voice notice (see steps S230 and 231 in FIG. 4).

Specifically, the drive-assist image I1 to be generated by the drive-assist information generator 16h is an image visibly representing, from the perspective of an outsider, circumstances of the arrangement of the vehicle V and other vehicles including the oncoming right-turn vehicle V21 of the assist zone AZ and therearound.

As one example, the drive-assist image can be generated by the drive-assist information generator 16h based on image data associated with the assist zone AZ taken by the camera C. The image data has been sent from the camera C to the provision task executing module 16 via the radio device 21 and the modules 11 and 12 using inter-vehicle communications and/or vehicle-roadside communications via the roadside device 31.

As another example, the drive-assist image can be generated by the drive-assist information generator 16h based on image data associated with the assist zone AZ stored in the storage medium 22a of the navigation device 22. The image data has been sent from the navigation device 22 to the provision task executing module 16.

The drive-assist voice notice to be generated by the drive-assist information generator 16h is a voice message for urging the driver to make an attention to pedestrians and straight oncoming vehicles on the opposing lanes before starting to turn right.

As one example, the drive-assist voice notice is that “CAUTION—STRAIGHT ONCOMING VEHICLES”.

This allows the display device 28 to display the generated drive-assist image I1, and the speaker 29 to output the generated drive-assist voice notice.

In the second circumferences illustrated in FIG. 4, the vehicle V waits at the traffic intersection TI in order to turn right when there are no forward right-turn vehicles. In the conditions, the driver of the vehicle V may not sufficiently make visual confirmation of the opposing lanes (the other two-lane section) of the road R1 due to the presence of the opposing right-turn vehicle V21.

In the conditions, because the vehicle V is temporarily halting, it is conceivable that the driver of the vehicle V:

may determine that the vehicle V cannot turn right at this moment; and

need look ahead to the opposing lanes and pedestrians before starting to turn right.

Thus, in the second circumferences, displaying the drive-assist image on the screen of the display device 28 and outputting the drive-assist voice notice by the speaker 29 can sufficiently assist the driver with his or her driving of the vehicle V.

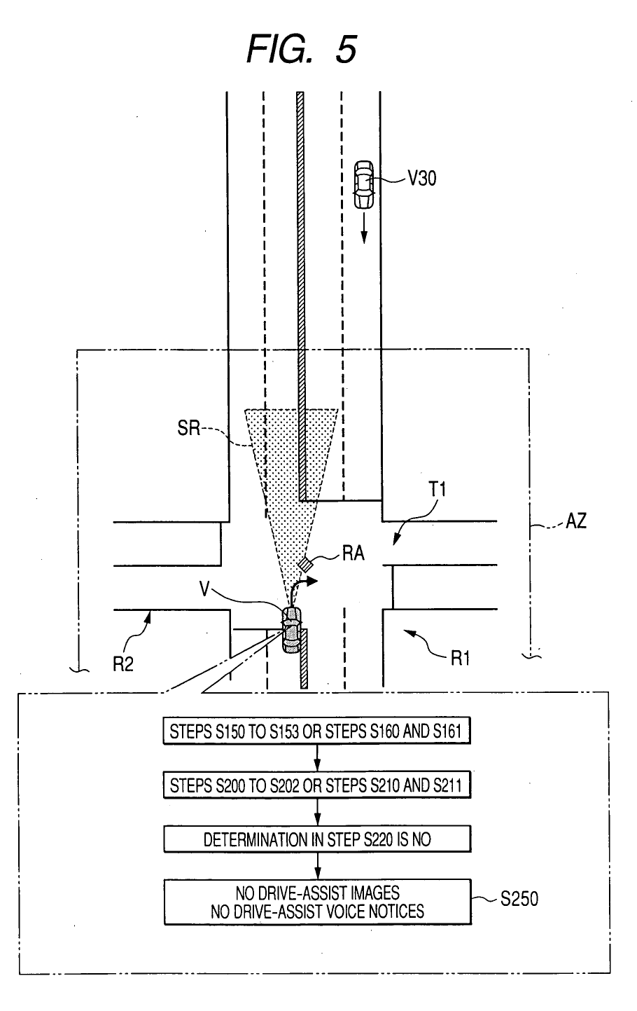

FIG. 5 schematically shows third circumstances in which:

the vehicle V is running at the traffic intersection TI on the inner lane of the one two-lane section of the road RI in order to turn right at the traffic intersection TI;

there are no forward right-turn vehicles on the inner lane of the one two-lane section of the road R1; and

there are no oncoming right-turn vehicles at the traffic intersection TI.

Note that reference character V30 represents a straight oncoming vehicle that is running, or temporarily stopping, toward the traffic intersection TI.

In this case, the identifying unit 16f determines that:

there are no forward right-turn vehicles (see steps S150 to S153 or steps S160 and S161);

there are no oncoming right-turn vehicles at the traffic intersection TI (see steps S200 to S202 or S210 and S211); and

the vehicle V is running at the traffic intersection TI on the inner lane of the one two-lane section of the road R1 in order to turn right at the traffic intersection TI (the determination in step S220 is NO).

Thus, the identifying unit 16f identifies that the current circumstances correspond to the third circumstances.

Specifically, when the current circumstances correspond to the third circumstances, because there are no forward right-turn vehicles and no oncoming right-turn vehicles within the traffic intersection TI, the driver of the vehicle V sufficiently can make visual confirmation of the opposing lanes (the other two-lane section) of the road R1.

Thus, it is conceivable that the driver of the vehicle V can easily confirm the existence of straight oncoming vehicles and pedestrians that become an obstacle to right-turn by only making a visual check for the opposing lanes.

In addition, when the vehicle V is turning right at the traffic intersection TI without temporarily halting thereat, it can be expected that the driver of the vehicle V decides to safely turn right after sufficiently confirming the circumstances in the traffic intersection TI.

Thus, in the third circumstances, the determining unit 16f determines that the level of necessity for provision of drive-assist information is low, which causes the drive-assist information generator 16h to generate no drive-assist images and no drive-assist voice notices (see step S250 in FIG. 5).

This allows the display device 28 not to display any drive-assist images, and the speaker 29 not to output any drive-assist voice notices, making it possible to reduce driver distraction due to drive-assist information and/or prevent drive-assist information from becoming bothersome for the driver of the vehicle V.

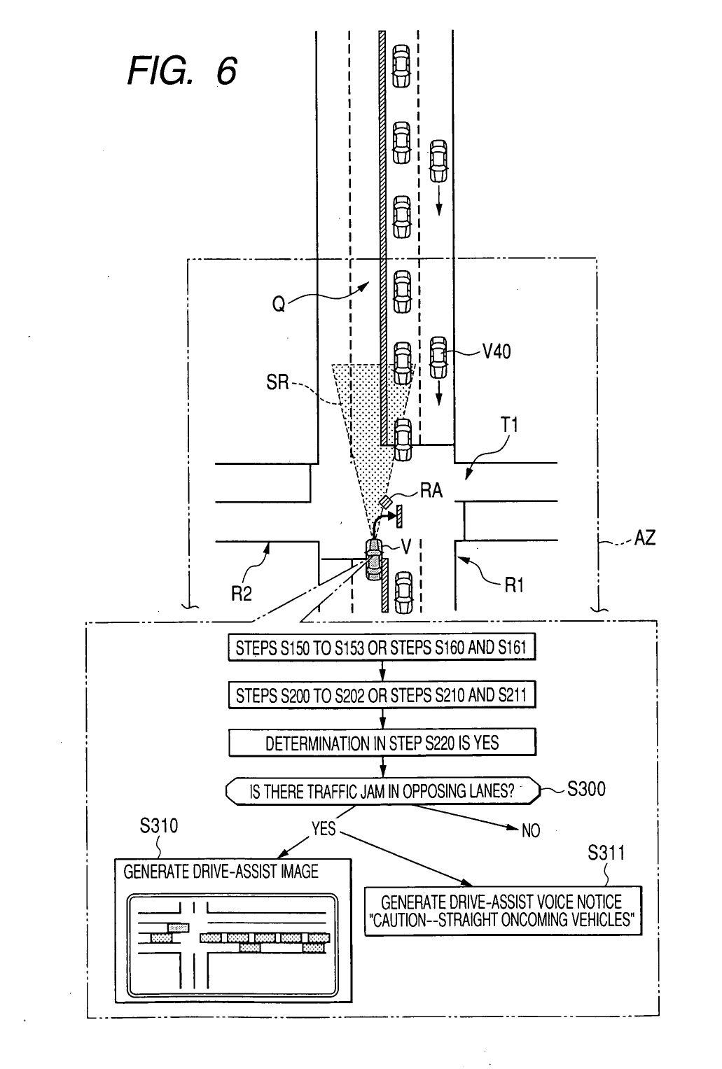

FIG. 6 schematically shows fourth circumstances in which:

the vehicle V is temporarily halting at the traffic intersection TI on the inner lane of the one two-lane section of the road R1 in order to turn right at the traffic intersection TI;

there are no forward right-turn vehicles on the inner lane of the one two-lane section of the road R1;

there are no oncoming right-turn vehicles at the traffic intersection TI; and

there is a traffic jam in the inner lane of the other two-lane section (the opposing lanes) of the road R1; this traffic jam consists of a queue Q of oncoming vehicles.

Note that reference character V40 represents straight oncoming vehicles that are running, or temporarily stopping, toward the traffic intersection TI.

In this case, the identifying unit 16f determines that:

there are no forward right-turn vehicles (see steps S150 to S153 or steps S160 and S161);

there are no oncoming right-turn vehicles at the traffic intersection TI (see steps S200 to S202 or S210 and S211);

the vehicle V is temporarily halting at the traffic intersection TI on the inner lane of the one two-lane section of the road R1 in order to turn right at the traffic intersection TI (the determination in step S220 is YES); and

there is a traffic jam in the inner lane of the other two-lane section of the road R1.

Thus, the identifying unit 16f identifies that the current circumstances correspond to the fourth circumstances.

The identifying unit 16f can carry out the determination of the presence or absence of a traffic jam in at least one lane of the other two-lane section of the road R1 based on the forward vehicle information passed from the module 15, the surrounding-vehicle information passed from the module 12, and the latest road traffic information including traffic-jam information associated with the traffic intersection TI.

Specifically, the surrounding-vehicle information passed from the module 12 includes the current positions and the behaviors of the oncoming vehicles detected by the radio device 21 using inter-vehicle communications and/or vehicle-roadside communications via the roadside device 31. In addition, as an example, the latest road traffic information including traffic-jam information associated with the traffic intersection TI has been sent from the navigation device 22. As another example, the latest road traffic information including traffic-jam information associated with the traffic intersection TI has been sent from the module 12; this latest road traffic information has detected by the radio device 21 using inter-vehicle communications and/or vehicle-roadside communications via the roadside device 31.

More specifically, the identifying unit 16f determines whether there is a traffic jam in at least one lane of the other two-lane section of the road R1 based on the received pieces of information set forth above in step S300 (see FIG. 6).

When it is determined that there is not a traffic jam in the other two-lane section (the determination in step S300 is NO), the identifying unit 16f can identify that the current circumstances do not correspond to the fourth circumstances.

Otherwise when it is determined that there is a traffic jam in the other two-lane section (the determination in step S300 is YES), the identifying unit 16f can identify that the current circumstances correspond to the fourth circumstances.

When the current circumstances correspond to the fourth circumstances, the determining unit 16f determines that the level of necessity for provision of drive-assist information is high, which causes the drive-assist information generator 16h to generate both a drive-assist image I2 and a drive-assist voice notice (see steps S310 and 311 in FIG. 6).

As in the case of the second circumstances, the drive-assist image I2 to be generated by the drive-assist information generator 16h is an image visibly representing, from a third party, circumstances of the arrangement of the vehicle V and other vehicles including the queue Q of oncoming vehicles of the assist zone AZ and therearound.

Moreover, the drive-assist voice notice to be generated by the drive-assist information generator 16h is a voice message for urging the driver to make an attention to pedestrians and straight oncoming vehicles on the opposing lanes before starting to turn right.

As one example, the drive-assist voice notice is that “CAUTION—STRAIGHT ONCOMING VEHICLES”.

This allows the display device 28 to display the generated drive-assist image I2, and the speaker 29 to output the generated drive-assist voice notice.

In the fourth circumstances illustrated in FIG. 6, even if there are no forward right-turn vehicles and no oncoming right-turn vehicles, the driver of the vehicle V may not sufficiently make visual confirmation of the outer lane of the opposing lanes of the road R1 due to the presence of the queue of oncoming vehicle on the inner lane of the opposing lanes.

In the conditions, because the vehicle V is temporarily halting, it is conceivable that the driver of the vehicle V:

may determine that the vehicle V cannot turn right at this moment; and

need look ahead to the opposing lanes and pedestrians before starting to turn right.

Thus, in the fourth circumferences, displaying the drive-assist image on the screen of the display device 28 and outputting the drive-assist voice notice by the speaker 29 can sufficiently assist the driver with his or her driving of the vehicle V.

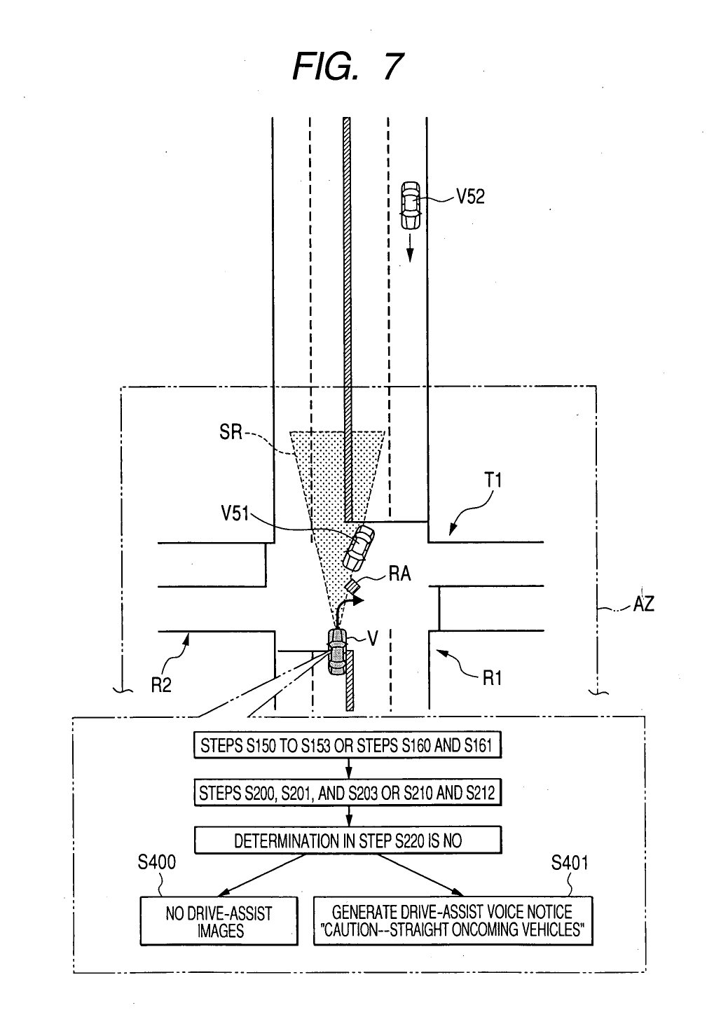

FIG. 7 schematically shows fifth circumstances in which:

the vehicle V is running at the traffic intersection TI on the inner lane of the one two-lane section of the road R1 in order to turn right at the traffic intersection TI;

there are no forward right-turn vehicles on the inner lane of the one two-lane section of the road R1; and

an oncoming vehicle 51 is turning right, or temporarily halting, at the traffic intersection TI.

Note that reference character V52 represents a straight oncoming vehicle that is running, or temporarily stopping, toward the traffic intersection TI.

In this case, the identifying unit 16f determines that:

there are no forward right-turn vehicles (see steps S150 to S153 or steps S160 and S161);

there is an oncoming right-turn vehicle at the traffic intersection TI (see steps S200, S201 and S203 or steps S210 and 212); and

the vehicle V is running at the traffic intersection TI on the inner lane of the one two-lane section of the road RI in order to turn right at the traffic intersection TI (the determination in step S220 is NO).

Thus, the identifying unit 16f identifies that the current circumstances correspond to the fifth circumstances.

Specifically, in the fifth circumstances illustrated in FIG. 7, the vehicle V is running at the traffic intersection TI in order to turn right when there are no forward right-turn vehicles. In the conditions, the driver of the vehicle V may not sufficiently make visual confirmation of the opposing lanes (the other two-lane section) of the road R1 due to the presence of the opposing right-turn vehicle V51. For this reason, it can be expected that some sort of drive-assist information is required for the driver of the vehicle V.

However, in the fifth circumstances, when the vehicle V is turning right at the traffic intersection TI without temporarily halting thereat, it is necessary to prevent the driver from his or her eyes away from the intersection TI and its surroundings due to the provision of drive-assist information.

Thus, in the fifth circumferences, the determining unit 16f determines that the level of necessity for provision of drive-assist information is set to a level requiring a drive-assist voice notice for the driver without any drive-assist images (see steps S400 and S401 in FIG. 7).

The drive-assist voice notice to be generated by the drive-assist information generator 16h is a voice message for urging the driver to make an attention to pedestrians and straight oncoming vehicles on the opposing lanes before starting to turn right.

As one example, the drive-assist voice notice is that “CAUTION—STRAIGHT ONCOMING VEHICLES”.

This allows the display device 28 not to display any drive-assist images, and the speaker 29 to output the drive-assist voice notice, making it possible to provide the drive-assist voice notice as the drive-assist information to the driver of the vehicle V without preventing the driver from his or her eyes away from the intersection TI and its surroundings.

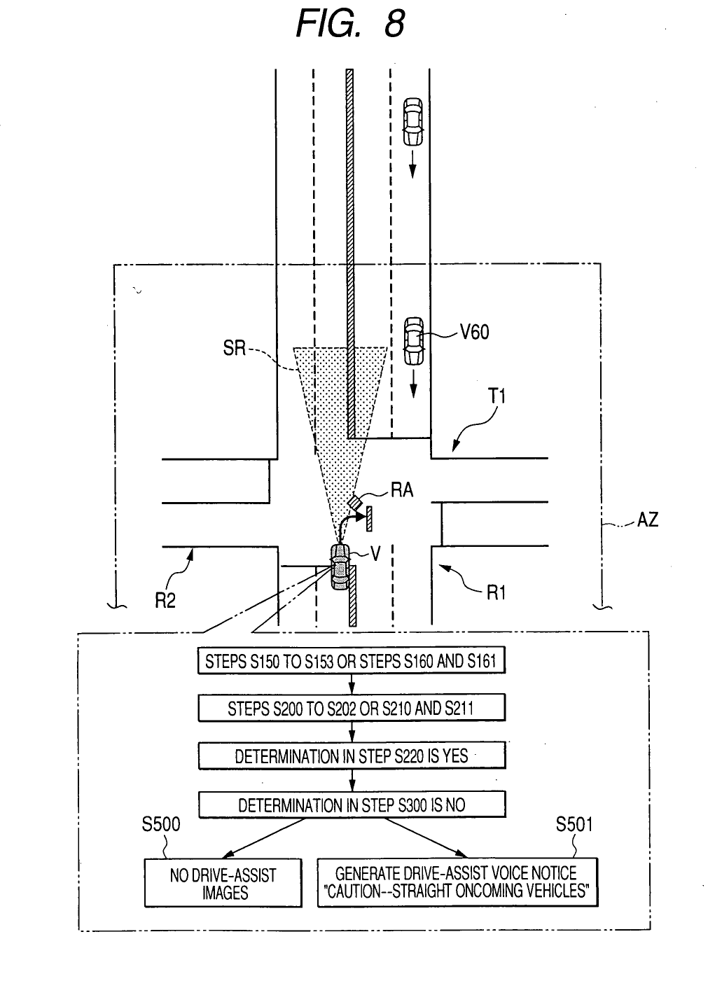

FIG. 8 schematically shows sixth circumstances in which:

the vehicle V is temporarily halting at the traffic intersection TI on the inner lane of the one two-lane section of the road R1 in order to turn right at the traffic intersection TI;

there are no oncoming right-turn vehicles at the traffic intersection TI; and

there are no traffic jams in the other two-lane section (the opposing lanes) of the road R1.

Note that reference character V60 represents a straight oncoming vehicle that is running, or temporarily stopping, toward the traffic intersection TI.

In this case, the identifying unit 16f determines that:

there are no forward right-turn vehicles (see steps S150 to S153 or steps S160 and S161);

there are no oncoming right-turn vehicles at the traffic intersection TI (see steps S200 to S202 or steps S210 and 211);

the vehicle V is temporarily halting at the traffic intersection TI on the inner lane of the one two-lane section of the road R1 in order to turn right at the traffic intersection TI (the determination in step S220 is YES); and

there are no traffic jams in the other two-lane section of the road R1 (the determination in step S300 is NO).

Thus, the identifying unit 16f identifies that the current circumstances correspond to the sixth circumstances.

Specifically, in the sixth circumstances illustrated in FIG. 8, there are no forward right-turn vehicles and no oncoming right-turn vehicles within the traffic intersection TI, and are no traffic jams in the opposing lanes of the road R1. For these reasons, it can be expected that the driver of the vehicle V allows sufficient visual confirmation of the opposing lanes (the other two-lane section) of the road R1. It is therefore conceivable that displaying of drive-assist images may become burden to the driver of the vehicle V.

However, under the conditions in which the vehicle V is temporarily halting to wait at the traffic intersection TI for right-turn, it is conceivable that information for urging the driver to make an attention to pedestrians and straight oncoming vehicles on the opposing lanes can be useful for the driver.

Thus, in the sixth circumferences, the determining unit 16f determines that the level of necessity for provision of drive-assist information is set to a level requiring a drive-assist voice notice for the driver without any drive-assist images (see steps S500 and S501 in FIG. 8).

The drive-assist voice notice to be generated by the drive-assist information generator 16h is a voice message for urging the driver to make an attention to pedestrians and straight oncoming vehicles on the opposing lanes before starting to turn right.

As one example, the drive-assist voice notice is that “CAUTION—STRAIGHT ONCOMING VEHICLES”.

This allows the display device 28 not to display any drive-assist images, and the speaker 29 to output the drive-assist voice notice, making it possible to provide the drive-assist voice notice as the drive-assist information to the driver of the vehicle V without limiting excessive information therefor.

Next, examples of drive-assist images displayed on the display device 28 will be described hereinafter.

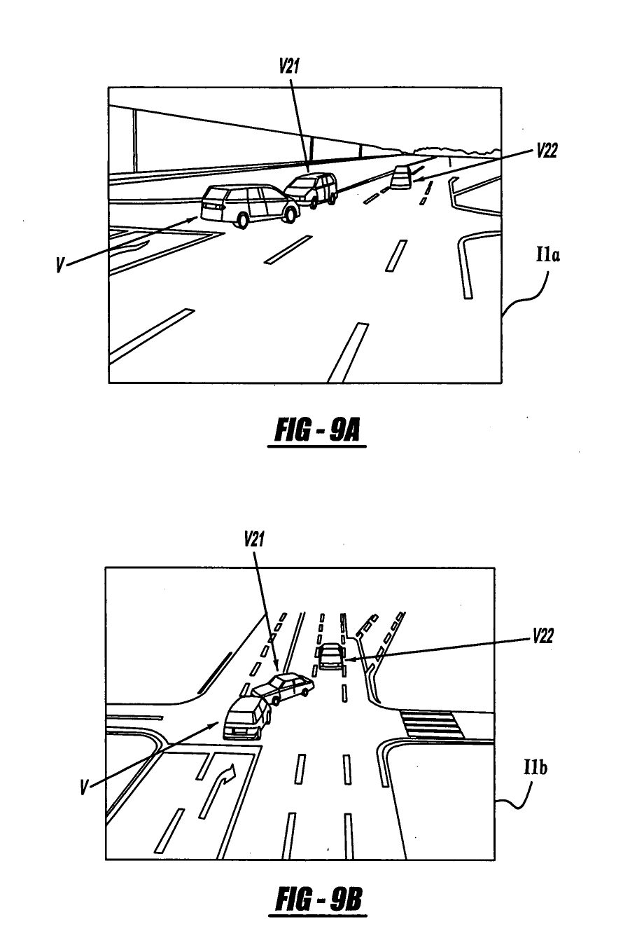

FIG. 9A schematically illustrates, as an example of drive-assist images, a camera image I1a displayed on the screen of the display device 28 and generated by the drive-assist information generator 16h based on image data associated with the assist zone AZ taken by the camera C for example, under the second circumstances (see FIG. 4). The image data has been sent from the camera C to the provision task executing module 16 via the radio device 21 and the modules 11 and 12 using inter-vehicle communications and/or vehicle-roadside communications via the roadside device 31.

In contrast, FIG. 9B schematically illustrates, as another example of drive-assist images, an animation image I1b displayed on the screen of the display device 28. For example, such an animation image can be generated by the drive-assist information generator 16h by superimposing data of the vehicle V and pieces of image data corresponding to other traffic items associated with the traffic intersection TI under, for example, the second circumstances (see FIG. 4) on a background image of the traffic intersection TI and therearound. All items of image data to be used to generate the animation image have been sent from the navigation device 22 to the provision task executing module 16.

Preferably, the drive-assist information generator 16h works to selectively generate any one of a camera image and an animation image based on the electric signals sent from the solar radiation sensor 26 and the rain gauge 27.

Camera images displayed on the screen of the display device 28 are based on images actually taken by the camera C, which visibly represents, from the perspective of an outsider, circumstances of the traffic intersection TI and its surroundings. Such camera images allow the driver of the vehicle V to visibly confirm, in detail, the circumstances of the traffic intersection TI and its surroundings including surrounding vehicles (opposing right-turn vehicles and/or straight opposing vehicles), pedestrians, roadsides, and sidewalks.

As set forth above, because camera images visibly represents actual circumstances of the traffic intersection TI and its surroundings, it is possible to increase the accuracy of drive-assist information to be provided to the driver of the vehicle V. Note that, however, the visibility of camera images based on actually taken-images by the camera C depends on the current weather in the traffic intersection TI and its surroundings, and depends on a current time period for which the images have been taken by the camera C.

Specifically, when images on which camera images are generated are taken by the camera C in the rain, the camera images may become dark images, and therefore, the visibility of the camera images may deteriorate.

Similarly, when images on which camera images are generated are taken by the camera C during the hours of darkness, the camera images may become dark images, and therefore, the visibility of the camera images may deteriorate.

On the other hand, animation images displayed on the screen of the display device 28 are computer graphic images generated based on image data stored in the storage medium 22a of the navigation device 22, which visibly represents, from the perspective of an outsider, circumstances of the traffic intersection TI and its surroundings.

Preferably, such animation images are generated by combining, for example, image data of the vehicle V and pieces of image data of, for example, other vehicles around the vehicle V on background image data of the traffic intersection TI and therearound. Information associated with the other vehicles around the vehicle V is comparatively higher in the level of necessity for the driver of the vehicle V. Thus, such animation images allow the driver of the vehicle V to visibly confirm, in detail, circumstances of the other vehicles around the vehicle V.

Such animation images can be immediately recognized by the driver of the vehicle V, and can be generated independently of the current weather in the traffic intersection TI and its surroundings and independently of the current time period for which the animation images have been generated by the drive-assist information generator 16h.

Accordingly, under the second circumstances or fourth circumstances, the drive-assist information generator 16h is configured to generate a camera image when the current weather is favorable during daytime hours (see steps S230 or S310). In contrast, under the second circumstances or fourth circumstances, the drive-assist information generator 16h is configured to generate an animation image in bad weather or in the nighttime (see steps S231 or S311).

Next, the drive-assist information providing task to be executable by the provision task executing module 16 of the in-vehicle drive-assist unit 10 will be described hereinafter. For example, at least one of the programs P stored in the memory unit 10b causes the CPU 10a to serves as the module 16 to execute the drive-assist information providing task.

For example, when determining that the vehicle V approaches an assist zone AZ corresponding to at least one traffic intersection TI based on the current location of the vehicle V passed from the module 13 and the position of the assist zone AZ sent from the navigation device, the CPU 10a launches the at least one of the programs P to thereby start the drive-assist information providing task.

As another example, when the driver or a passenger in the front seat manipulates the input device 10d to enter the start of drive-assist information providing task into the CPU 10a, the CPU 10a launches the at least one of the programs P to thereby start the drive-assist information providing task.

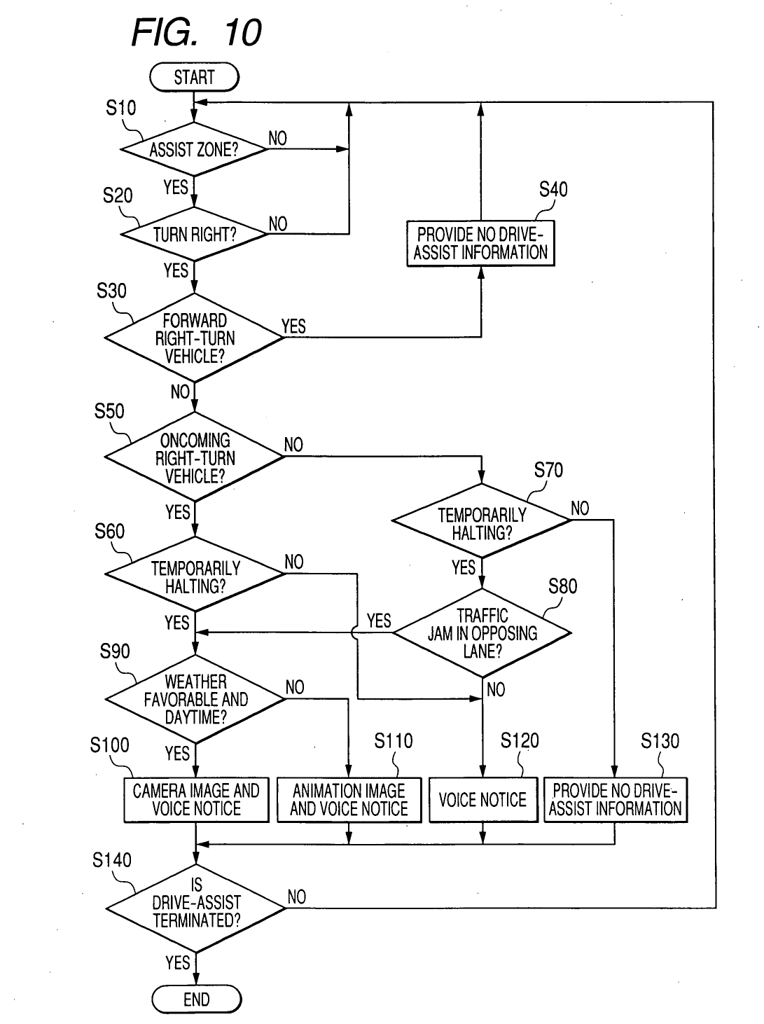

After starting the drive-assist information providing task, the module 16 determines whether the vehicle V has reached an assist zone AZ based on the current location of the vehicle V passed from the module 13 and the position of the assist zone AZ sent from the navigation device 22 in step S10 of FIG. 10.

When it is determined that the vehicle V has not reached the assist zone AZ (the determination in step S10 is NO), the module 16 repeats the determination in step S10 in predetermined cycles until the determination is affirmative.

When it is determined that the vehicle V has reached the assist zone AZ (the determination in step S10 is YES), the module 16 proceeds to step S20.

In step S20, the module 16 determines whether the vehicle V wants to turn right at the traffic intersection TI corresponding to the assist zone AZ based on, for example, the information indicative of operating conditions of the front and rear indicators of the vehicle V sent from the body ECU 25 in step S20.

Specifically, when the received information represents that the right direction indicators are blink on, the module 16 determines that the vehicle V wants to turn right at the traffic intersection TI, proceeding to step S30. Otherwise, when the received information represents that the right direction indicators are off state, proceeding to step S10 and repeating the process in step S10.

Note that, in step S20, in order to more reliably confirm that the vehicle V wants to turn right at the traffic intersection TI, in addition to the right-indicator information, the module 16 can perform the turn-right determination using information indicative of a lane on which the vehicle V is running or temporarily halting. In other words, the module 16 can carry out the turn-right determination using information indicative of whether the vehicle V is running or temporarily halting on a right turn lane of the road R1. Various means for determination of whether a vehicle is running or temporarily halting on a right turn lane have been well-known.

For example, assuming that an in-vehicle camera VC, which is illustrated by a two-dot chain line in FIG. 1, has been installed in the vehicle V, the in-vehicle camera VC can work to take images around the vehicle V, such as images of the lane markings of roads, and send the taken images to the module 16. The module 16 can therefore determine whether the vehicle V is running or temporarily halting on a right turn lane of the road R1 based on the positions of the lane markings of roads obtained by the taken images.

In step S30, the module 16 determines whether there is a forward right-turn vehicle in front of the vehicle V using, for example, the processes in steps S150 to S154 or steps S160 to S162 illustrated in FIG. 3.

When it is determined that there is a forward right-turn vehicle in front of the vehicle V (the determination in step S30 is YES), the module 16 identifies that the current circumstances correspond to the first circumstances (see FIG. 3). The module 16 therefore returns to step S10 without providing any drive-assist information in step S40 corresponding to step S170.

Otherwise when it is determined that there are not any forward right-turn vehicles in front of the vehicle V (the determination in step S30 is NO), the module 16 proceeds to step S50.

In step S50, the module 16 determines whether there is an oncoming right-turn vehicle using, for example, the processes in steps S200 to S203 or steps S210 to S212 illustrated in FIG. 4.

When it is determined that there is an oncoming right-turn vehicle (the determination in step S50 is YES), the module 16 proceeds to step S60.

In step S60, the module 16 determines whether the vehicle V is temporarily halting at the traffic intersection TI using, for example, the process in step S220 illustrated in FIG. 4.

When it is determined that the vehicle V is temporarily halting at the traffic intersection TI (the determination in step S60 is YES), the module 16 identifies that the current circumstances correspond to the second circumstances, and that the level of necessity for provision of drive-assist information is high (see FIG. 4), proceeding to step S90.

In step S90, the module 16 determines whether the whether is favorable during daytime hours based on the electric signals sent from the solar radiation sensor 26 and the rain gauge 27. The electric signal currently sent from the sensor 26 represents that the measured solar radiation, and the electric signal currently sent from the rain gauge 27 represents that the measured amount of rainfall.

For example, when both the measured solar radiation is greater than a predetermined threshold radiation, and the measured amount of liquid precipitation is equal to or lower than a predetermined threshold amount, the module 16 determines that the whether is favorable during daytime hours (the determination in step S90 is YES). Then, the module proceeds to step S100.

In step S100, the module 16 generates a camera image I1a based on image data associated with the assist zone AZ taken by the camera C under the second circumstances (see step S230 in FIG. 4). In step S100, the module 16 also generates a drive-assist voice notice for urging the driver of the vehicle V to make an attention to pedestrians and straight oncoming vehicles on the opposing lanes before starting to turn right (see step 231 in FIG. 4).

Thereafter, in step S100, the module 16 sends the camera image I1a to the display device 28 so as to display it on the screen thereof, and sends the drive-assist voice notice to the speaker 29 so as to output it thereby, proceeding to step S140.

Otherwise when either the measured solar radiation is equal to or lower than the predetermined threshold radiation, or the measured amount of liquid precipitation is greater than the predetermined threshold amount, the module 16 determines that the whether is bad or the current time period is nighttime (the determination in step S90 is NO). Then, the module proceeds to step S110.

In step S10, the module 16 generates an animation image I1b by superimposing data of the vehicle V and pieces of image data corresponding to other traffic items associated with the traffic intersection TI under the second circumstances (see FIG. 4) on a background image of the traffic intersection TI and therearound (see step 230 in FIG. 4).

In step S110, the module 16 also generates a drive-assist voice notice for urging the driver of the vehicle V to make an attention to pedestrians and straight oncoming vehicles on the opposing lanes before starting to turn right (see step 231 in FIG. 4).

Thereafter, in step S110, the module 16 sends the animation image I1b to the display device 28 so as to display it on the screen thereof, and sends the drive-assist voice notice to the speaker 29 so as to output it thereby, proceeding to step S140.

On the other hand, when it is determined that there are no oncoming right-turn vehicles (the determination in step S50 is NO), the module 16 proceeds to step S70.

In step S70, the module 16 determines whether the vehicle V is temporarily halting at the traffic intersection TI using, for example, the process in step S220 illustrated in FIG. 4.

When it is determined that the vehicle V is not temporarily halting at the traffic intersection TI (the determination in step S70 is NO), the module 16 identifies that the current circumstances correspond to the third circumstances, and that the level of necessity for provision of drive-assist information is high (see FIG. 5). Then the module 16 proceeds to step S140 without providing any drive-assist information in step S130 corresponding to step S250.

Otherwise when it is determined that the vehicle V is temporarily halting at the traffic intersection TI (the determination in step S70 is YES), the module 16 determines whether there is a traffic jam in the opposing lanes of the road R1 within the assist zone AZ in step S80 corresponding to step S300 in FIG. 6.

When it is determined that there is a traffic jam in the opposing lanes of the road R1 within the assist zone AZ (the determination in step S80 is YES), the module 16 identifies that the current circumstances correspond to the fourth circumstances, proceeding to step S90 and executing the processes in steps S90 and S100 or S110.

Specifically, when it is determined that the whether is favorable during daytime hours, (the determination in step S90 is YES), the camera image is displayed on the screen of the display device 28 and the drive-assist voice notice is outputted by the speaker 29 (see step S100).

Otherwise when that the whether is bad or the current time period is nighttime (the determination in step S90 is NO), the animation image is displayed on the screen of the display device 28 and the drive-assist voice notice is outputted by the speaker 29 (see step S110).

On the other hand, when it is determined that the vehicle V is not temporarily halting at the traffic intersection TI (the determination in step S60 is NO), the module 16 determines that the current circumstances correspond to the fifth circumstances (see FIG. 7), proceeding to step S120. Similarly, when it is determined that there are no traffic jams in the opposing lanes of the road R1 within the assist zone AZ (the determination in step S80 is NO), the module 16 determines that the current circumstances correspond to the sixth circumstances (see FIG. 8), proceeding to step S120.

In step S120, the module 16 generates a drive-assist voice notice for urging the driver of the vehicle V to make an attention to pedestrians and straight oncoming vehicles on the opposing lanes before starting to turn right without generating any drive-assist images (see steps S400 and S401 in FIG. 7 or steps S500 and S501 in FIG. 8). Thereafter, in step S120, the module 16 sends the drive-assist voice notice to the speaker 29 so as to output it thereby, proceeding to step S140.

In step S140, the module 16 determines whether the drive-assist information providing task is terminated.

For example, in step S140, when determining that the vehicle V is running, or temporarily halting, within the assist zone AZ based on the current location of the vehicle V passed from the module 13 and the position of the assist zone AZ sent from the navigation device, the determination in step S140 is negative. Then, the module 16 returns to step S10, repeatedly executing the process in step S10.

In contrast, when determining that the vehicle V has gone out of the assist zone AZ based on the current location of the vehicle V passed from the module 13 and the position of the assist zone AZ sent from the navigation device, the determination in step S140 is affirmative. Then, the module 16 terminates the drive-assist information providing task.

As another example, when no instructions indicative of the termination of drive-assist information providing task has been input to the CPU 10a, the determination in step S140 is NO. Then, the module 16 returns to step S10, repeatedly executing the process in step S10.

In contrast, when an instruction indicative of the termination of drive-assist information providing task has been input to the CPU 10a, the determination in step S140 is affirmative. Then, the module 16 terminates the drive-assist information providing task.

As described above, the drive-assist information providing system 1 is configured to identify the current circumstances of the vehicle V and therearound by checking:

(1) the presence or absence of forward right-turn vehicles;

(2) the presence or absence of oncoming right-turn vehicles;

(3) the presence or absence of traffic jams in an opposing lane(s); and

(4) the running state or halting state of the vehicle V.

In addition, the drive-assist information providing system 1 is configured to:

determine the level of necessity for provision of drive-assist information for the driver of the vehicle V under the identified current circumstances of the vehicle V and therearound; and

assist the driver with his or her driving of the vehicle V in more appropriate manner for the driver based on the level of necessity for provision of drive-assist information; this level corresponds to the current circumstances of the vehicle V and therearound.

Specifically, it is assumed that the current circumstances of the vehicle V and therearound correspond to either the first circumstances (see FIG. 3) or the third circumstances (see FIG. 5) in which the level of necessity for provision of drive-assist information is low.

In this assumption, the drive-assist information providing system 1 is configured to prevent drive-assist information from being supplied to the driver of the vehicle V. This makes it possible to reduce driver distraction due to drive-assist information and/or prevent drive-assist information from becoming bothersome for the driver of the vehicle V.

It is assumed that the current circumstances of the vehicle V and therearound correspond to either the second circumstances (see FIG. 4) or the fourth circumstances (see FIG. 6) in which the level of necessity for provision of drive-assist information is high.

In this assumption, the drive-assist information providing system 1 is configured to provide, as drive-assist information, both drive-assist images and drive-assist voice notices to the driver. This makes it possible to sufficiently assist the driver with his or her driving of the vehicle V.

It is assumed that that the current circumstances of the vehicle V and therearound correspond to either the fifth circumstances (see FIG. 7) or the sixth circumstances (see FIG. 8) in which the level of necessity for provision of drive-assist information is set to a level that requires a drive-assist voice notice for the driver without any drive-assist images.

In this assumption, the drive-assist information providing system 1 is configured to provide, as drive-assist information, drive-assist voice notices to the driver without providing any drive-assist images thereto.

This makes it possible to:

provide the drive-assist voice notice as the drive-assist information to the driver of the vehicle V without preventing the driver from his or her eyes away from the intersection TI and its surroundings; and

reduce driver distraction due to drive-assist information and/or prevent drive-assist information from becoming bothersome for the driver of the vehicle V.

Under the second or fourth circumstances, the drive-assist information providing system 1 is also configured to provide, to the driver of the vehicle V, camera images visibly representing actual circumstances of the traffic intersection TI and its surroundings when the current weather is favorable during daytime hours.

In contrast, under the second or fourth circumstances, the drive-assist information providing system 1 is configured to provide, to the driver of the vehicle V, animation images with a comparative high visibility when the current weather is bad or the current time period is nighttime.

Accordingly, it is possible to appropriately display any one of camera images and animation images while utilizing the advantages of both the camera images and animation images depending on the current conditions.

In the embodiment, the drive-assist information providing system 1 is composed of, as devices for non-visibly outputting drive-assist information, the speaker 29 that works to output audible sound information as drive-assist information, but the present invention is not limited to the structure.

Specifically, devices NV for non-visibly outputting drive-assist information in various non-visible information-providing manners, which are illustrated by a two-dot chain line in FIG. 1, can be installed in the vehicle V and electrically connected to the in-vehicle drive-assist unit 10. For example, the devices NV for non-visibly outputting drive-assist information include at least one vibrator mounted on the driver's seat of the vehicle V or on the steering wheel of the vehicle V. The at least one vibrator is operative to produce vibratory motion.

The drive-assist information generator 16h can work to drive the at least one vibrator to produce vibratory motion to be provided to the driver in place of drive-assist voice notices thereto.

As another example, the devices NV for non-visibly outputting drive-assist information include an air conditioner installed in the vehicle V and operative to control temperature and humidity within the body of the vehicle V.

Specifically, the drive-assist information generator 16h can work to control the air conditioner to thereby cause it to periodically output air into the vehicle V. The periodically outputted air allows non-visible information to be provided to the driver.

Under the second circumstances or fourth circumstances, the drive-assist information providing system 1 is designed to use both drive-assist images and drive-assist voice notices, but can be designed to use only drive-assist images or drive-assist voice notices.

In this modification, a voice message for urging the driver to make an attention to pedestrians and straight oncoming vehicles on the opposing lanes before starting to turn right can be displayed on the screen of the display device 28 to be superimposed, as a text image, on a drive-assist image. The text image can be displayed on another display, such as a head-up display (HUD) operative to project the text image onto a screen located in front of the driver's eyes, a sub-display, an indicator, or the like.

In place of using the electric signal indicative of the measured solar radiation sent from the solar radiation sensor 26, in order to determine whether the current time period is daytime, the provision task executing module 16 can use:

information indicative of the current time sent from the navigation device 22 or the in-vehicle clock;

images around the vehicle V taken by the in-vehicle camera VC; or information indicative of the operating conditions of the headlights sent from the body ECU 25.

In place of using the electric signal indicative of the measured amount of liquid precipitation, in order to determine whether the current weather is favorable, the provision task executing module 16 can use:

images around the vehicle V taken by the in-vehicle camera VC; or

information indicative of the operating conditions of the wipers sent from the body ECU 25.

In the embodiment, a predetermined communicable area containing at least one traffic intersection and a given radius of the at least one traffic section has been established as the assist zone AZ, but the present invention is not limited to the descriptions.

Specifically, a predetermined area containing a point of various roads and a given radius thereof can have been established as an assist zone AZ.

In addition, the drive-assist information providing system 1 can be installed as drive-assist information providing functions in a vehicle navigation system.

For example, as illustrated in FIG. 1, the drive-assist information providing system 1 can be regarded as a vehicle navigation system.

Specifically, the vehicle navigation system 1 can be operative to display a current vehicle's exact location and a readout electronic map image associated with the vehicle's exact location obtained by the navigation device 22 on the screen of the display device 28.

In addition, the vehicle navigation system 1 can be operative to give an occupant(s) voice or visual guidance to occupant's destination along a calculated best route from a current location, which is obtained by the navigation device 22, using the display device 28 and/or the speaker 29.

The vehicle navigation system 1 according to the embodiment can be operative to display drive-assist images as drive-assist information on the map image and/or the visual guidance as need arises, such as under the second circumstances or fourth circumstances. In addition, the vehicle navigation system 1 can be operative to provide drive-assist voice notices as drive-assist information to the driver of the vehicle V as need arises, such as under the second circumstances or fourth circumstances.

The vehicle periphery monitoring device 24 can include, in addition to the front vehicle detector, a rear vehicle monitor, a right-side vehicle monitor, and a left-side vehicle monitor. The rear vehicle monitor is operative to detect objects (obstacles, such as other vehicles) in the rear of the vehicle V. The right-side vehicle monitor is operative to monitor objects in the right side of the vehicle V. The left-side vehicle monitor is operative to monitor objects in the left side of the vehicle V.

Pieces of information detected by the front, rear, right-side, and left-side monitors can be set to the surrounding-vehicle detecting module 15 as surrounding-vehicle information. The surrounding-vehicle detecting module 15 can work to receive the surrounding-vehicle information sent from the monitors of the vehicle peripheral monitoring device 24 to thereby identify the existences (locations) and behaviors of surrounding vehicles located around the vehicle V. The surrounding-vehicle detecting module 15 can work to pass, to the provision task executing module 16, information indicative of the existences and behaviors of surrounding objects located around the vehicle V in place of the forward-vehicle information.

The vehicle peripheral monitoring device 24 and/or the in-vehicle camera VC can be installed in the vehicle V to be used only for the drive-assist information providing system 1. Moreover, such vehicle peripheral monitoring devices and/or in-vehicle cameras, which have been previously installed in the vehicle V as components of other in-vehicle systems. For example, the other in-vehicle systems include an ACC (Automatic Cruise Control) system, a PCS (Pre-crash safety) system, a LKA (Lane Keep Assist) system, or the like.

The ACC system uses at least one sensor in front of the vehicle V to scan the area ahead of the vehicle V for objects, mainly other vehicles, and apply the brakes automatically if a collision is likely to occur.

The PCS system uses at least one radar and at least one camera mounted on the vehicle V to detect imminent crashes and reduce collision impact.

The LKA system uses at least one camera placed, for example, next to the rear-window mirror for monitoring the lane markings of roads so as to control the vehicle's steering.

The drive-assist information providing system 1 can be configured to dynamically change the descriptions of drive-assist information to be provided to the driver of the vehicle V by visibly outputting devices, such as the display device 28 and non-visibly outputting devices, such as the speaker 29.

For example, in each of steps S100 and S110, the provision task executing module 16 can be configured to:

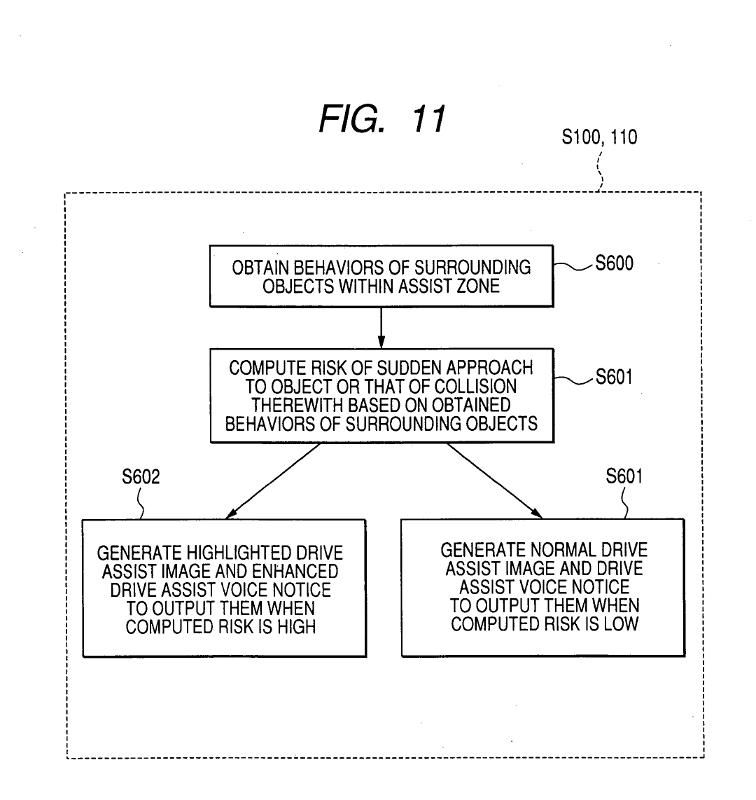

obtain the behaviors of surrounding objects, mainly surrounding vehicles, within the assist zone AZ based on information indicative of the existences and behaviors of surrounding objects located around the vehicle V sent from the vehicle peripheral monitoring device 24 in step S600 of FIG. 11;

compute the risk of sudden approach to an object or that of collision therewith based on the obtained behaviors of the surrounding objects in step S601;

normally generate a normal drive-assist image and a normal drive-assist voice notice so as to output them via the display device 28 and speaker 29, respectively, when the computed risk is low in step S602; and

generate a highlighted drive-assist image and an enhanced drive-assist voice notice so as to output them via the display device 28 and speaker 29, respectively, when the computed risk is high in step S603.

For example, when the computed risk represents that there is a concern for sudden approach to a straight oncoming vehicle or that of collision therewith in step S601, the provision task executing module 16:

generates a highlighted visual message for urging the driver to make an attention to straight oncoming vehicles so as to display it on the screen of the display device 28 in a pop-up window; and

generates a loud voice message for urging the driver to make an attention to straight oncoming vehicles so as to output it by the speaker 29.

While there has been described what is at present considered to be the embodiment and its modifications of the present invention, it will be understood that various modifications which are not described yet may be made therein, and it is intended to cover in the appended claims all such modifications as fall within the true spirit and scope of the invention.

What is claimed is:

1. A drive-assist information providing system installed in a vehicle and designed to provide drive-assist information to a driver of the vehicle when the vehicle is running, or temporarily halting, on one lane of a road within a predetermined assist zone, the system comprising:
a first obtaining unit configured to obtain a current position and behavior of the vehicle;
a second obtaining unit configured to obtain a current position and behavior of at least one object around the vehicle;
an identifying unit configured to identify current circumstances of the vehicle and therearound based on the current position and behavior of the vehicle and on the current position and behavior of the at least one object around the vehicle; and
a control unit configured to control how to provide the drive-assist information to the driver of the vehicle depending on the identified current circumstances of the vehicle and therearound.

2. A drive-assist information providing system according to claim 1, wherein the predetermined assist zone contains a traffic intersection, and the vehicle is running, or temporarily halting, on the one lane of the road within the predetermined assist zone toward the traffic intersection for changing a predetermined direction thereat while crossing an opposing lane of the road, and the drive-assist information to be provided to the driver of the vehicle is associated with conditions of the traffic intersection and therearound.

3. A drive-assist information providing system according to claim 2, wherein the identifying unit is configured to identify the current circumstances of the vehicle and therearound by executing, based on the current position and behavior of the vehicle and on the current position and behavior of the at least one object around the vehicle, at least one of first to fourth determinations,
the first determination being whether there is a forward vehicle located on the one lane of the road in front of the vehicle,
the second determination being whether there is an oncoming vehicle that approaches the traffic intersection on the opposing lane in order to change a direction thereat toward the one lane of the road;
the third determination being whether there is a traffic jam in the opposing lane; and
the fourth determination being whether the vehicle is temporarily halting.

4. A drive-assist information providing system according to claim 3, wherein the control unit is configured to determine, depending on the identified current circumstances of the vehicle and therearound:
whether to provide the drive-assist information to the driver of the vehicle; and
which provision modes of the drive-assist information to be given to the driver of the vehicle when it is determined to provide the drive-assist information to the driver of the vehicle.

5. A drive-assist information providing system according to claim 4, further comprising:
a first output unit configured to output information to be visibly recognizable by the driver of the vehicle; and
a second output unit configured to output information to be non-visibly recognizable by the driver of the vehicle,
wherein the control unit is configured to select at least one of the first and second output units based on the determined one of the provision modes to thereby cause the selected at least one of the first and second output units to output the drive-assist information.

6. A drive-assist information providing system according to claim 5, wherein the identifying unit is configured to identify that the current circumstances of the vehicle and therearound correspond to first circumstances when it is determined that there is a forward vehicle in front of the vehicle based on execution of the first determination, and wherein the control unit works to determine not to provide the drive-assist information to the driver of the vehicle based on the first circumstances.

7. A drive-assist information providing system according to claim 5, wherein the identifying unit is configured to identify that the current circumstances of the vehicle and therearound correspond to second circumstances when it is determined that:
there is not a forward vehicle in front of the vehicle based on execution of the first determination;
there is an oncoming vehicle that approaches the traffic intersection on the opposing lane in order to change a direction thereat toward the one lane of the road based on execution of the second determination; and
the vehicle is temporarily halting based on execution of the fourth determination,
and wherein the control unit works, based on the identified second circumstances, to:
determine to provide the drive-assist information to the driver of the vehicle; and
determine one of the provision modes to select at least the first output unit to thereby cause the selected first output unit to output the drive-assist information.

8. A drive-assist information providing system according to claim 5, wherein the identifying unit is configured to identify that the current circumstances of the vehicle and therearound correspond to third circumstances when it is determined that:
there is not a forward vehicle in front of the vehicle based on execution of the first determination;
there is not an oncoming vehicle that approaches the traffic intersection on the opposing lane in order to change a direction thereat toward the one lane of the road based on execution of the second determination; and
the vehicle is not temporarily halting based on execution of the fourth determination,
and wherein the control unit works to determine not to provide the drive-assist information to the driver of the vehicle based on the identified third circumstances.

9. A drive-assist information providing system according to claim 5, wherein the identifying unit is configured to identify that the current circumstances of the vehicle and therearound correspond to fourth circumstances when it is determined that:
there is not a forward vehicle in front of the vehicle based on execution of the first determination;
there is not an oncoming vehicle that approaches the traffic intersection on the opposing lane in order to change a direction thereat toward the one lane of the road based on execution of the second determination;
the vehicle is temporarily halting based on execution of the fourth determination; and
there is a traffic jam in the opposing lane,
and wherein the control unit works, based on the identified fourth circumstances, to:
determine to provide the drive-assist information to the driver of the vehicle; and
determine one of the provision modes to select at least the first output unit to thereby cause the selected first output unit to output the drive-assist information.

10. A drive-assist information providing system according to claim 5, wherein the identifying unit is configured to identify that the current circumstances of the vehicle and therearound correspond to fifth circumstances when it is determined that:
there is not a forward vehicle in front of the vehicle based on execution of the first determination;
there is an oncoming vehicle that approaches the traffic intersection on the opposing lane in order to change a direction thereat toward the one lane of the road based on execution of the second determination; and
the vehicle is not temporarily halting based on execution of the fourth determination,
and wherein the control unit works, based on the identified fifth circumstances, to:
determine to provide the drive-assist information to the driver of the vehicle; and
determine one of the provision modes to select the second output unit to thereby cause the selected second output unit to output the drive-assist information.

11. A drive-assist information providing system according to claim 5, wherein the identifying unit is configured to identify that the current circumstances of the vehicle and therearound correspond to sixth circumstances when it is determined that:
there is not a forward vehicle in front of the vehicle based on execution of the first determination;
there is not an oncoming vehicle that approaches the traffic intersection on the opposing lane in order to change a direction thereat toward the one lane of the road based on execution of the second determination;
the vehicle is temporarily halting based on execution of the fourth determination; and
there is not a traffic jam in the opposing lane,
and wherein the control unit works, based on the identified sixth circumstances, to:
determine to provide the drive-assist information to the driver of the vehicle; and
determine one of the provision modes to select the second output unit to thereby cause the selected second output unit to output the drive-assist information.

12. A drive-assist information providing system according to claim 5, further comprising:
a time-period information measuring unit configured to measure information to determine whether a current time period is daytime or nighttime;
a weather information measuring unit configured to measure information to determine whether a current weather is favorable;
a determining unit configured to determine whether the current time period is daytime and the current weather is favorable based on the information measured by the time-period information measuring unit and the information measured by the weather information measuring unit;
a camera image receiving unit configured to externally receive, as one of the drive-assist information, a camera image, the camera image visibly representing circumstances of the traffic intersection and its surroundings; and
an animation image generating unit storing therein background image data of the traffic intersection and therearound, image data of the vehicle and image data of the at least one object around the vehicle, the animation image generating unit working to generate an animation image by combining the background image data with both the image data of the vehicle and the image data of the at least one object around the vehicle based on the current position and behavior of the vehicle and on the current position and behavior of the at least one object around the vehicle,
wherein the control unit is configured to, when selecting the first output unit based on the determined one of the provision modes, select any one of the camera image and animation image based on the determination result of the determining unit to thereby cause the first output unit to display the selected one of the camera image and the background image.

13. A drive-assist information providing system according to claim 1, wherein at least one monitoring device has been installed in the vehicle, the at least one monitoring device working to monitor the at least one object around the vehicle and to output information indicative of the monitoring to the second obtaining unit, and the second obtaining unit is configured to obtain the current position and behavior of the at least one object around the vehicle based on the information indicative of the monitoring output from the at least one monitoring device.

14. A drive-assist information providing system according to claim 1, wherein the second obtaining unit is configured to wirelessly communicate with a roadside device installed on a roadside within the assist zone, the roadside device working to monitor the at least one object around the vehicle, and the second obtaining unit is configured to wirelessly access the roadside device to receive information indicative of the monitoring therefrom to thereby obtain the current position and behavior of the at least one object around the vehicle based on the received information.

15. A drive-assist information providing system according to claim 1, wherein a wirelessly communication device has been installed in the at least one object, the wirelessly communication device of the at least one object working to obtain the current position and behavior thereof, and the second obtaining unit is configured to wirelessly access the wirelessly communication device to receive information indicative of the current position and behavior of the at least one object therefrom to thereby obtain the current position and behavior of the at least one object around the vehicle based on the received information.

16. A program product embedded in a media accessible by a computer installed in a vehicle for providing drive-assist information to a driver of the vehicle when the vehicle is running, or temporarily halting, on one lane of a road within a predetermined assist zone, the program product comprising:
first means for instructing a computer to, when a current position and behavior of at least one object around the vehicle is externally input thereto, receive the current position and behavior of at least one object around the vehicle;
second means for instructing a computer to, when a current position and behavior of at least one object around the vehicle is externally input thereto, receive the current position and behavior of the at least one object around the vehicle;
third means for instructing a computer to identify current circumstances of the vehicle and therearound based on the current position and behavior of the vehicle and on the current position and behavior of the at least one object around the vehicle; and
fourth means for instructing a computer to control how to provide the drive-assist information to the driver of the vehicle depending on the identified current circumstances of the vehicle and therearound.

17. A program product according to claim 16, wherein the predetermined assist zone contains a traffic intersection, and the vehicle is running, or temporarily halting, on the one lane of the road within the predetermined assist zone toward the traffic intersection for changing a predetermined direction thereat while crossing an opposing lane of the road, and the drive-assist information to be provided to the driver of the vehicle is associated with conditions of the traffic intersection and therearound.

18. A program product according to claim 17, wherein the third means is designed to instruct a computer to identify the current circumstances of the vehicle and therearound by executing, based on the current position and behavior of the vehicle and on the current position and behavior of the at least one object around the vehicle, at least one of first to fourth determinations,
the first determination being whether there is a forward vehicle located on the one lane of the road in front of the vehicle,
the second determination being whether there is an oncoming vehicle that approaches the traffic intersection on the opposing lane in order to change a direction thereat toward the one lane of the road;
the third determination being whether there is a traffic jam in the opposing lane; and
the fourth determination being whether the vehicle is temporarily halting.

19. A program product according to claim 18, wherein the fourth means is designed to instruct a computer to determine, depending on the identified current circumstances of the vehicle and therearound:
whether to provide the drive-assist information to the driver of the vehicle; and
which provision modes of the drive-assist information to be given to the driver of the vehicle when it is determined to provide the drive-assist information to the driver of the vehicle.
